(19) United States
(12) Patent Application Publication
(10) Pub. No.: US 2026/0186269 A1
(43) Pub. Date: Jul. 2, 2026

(54) OPTICAL IMAGING SYSTEM

(71) Applicant: SAMSUNG ELECTRO-MECHANICS CO., LTD., Suwon-si (KR)

(72) Inventors: Su Hyeok LEE, Suwon-si (KR); Dong Hyuk JANG, Suwon-si (KR); Sang Hyun JANG, Suwon-si (KR)

(73) Assignee: SAMSUNG ELECTRO-MECHANICS CO., LTD., Suwon-si (KR)

(21) Appl. No.: 19/330,212

(22) Filed: Sep. 16, 2025

(30) Foreign Application Priority Data
Dec. 31, 2024 (KR) 10-2024-0201621

(51) Int. Cl. G02B 13/00; G02B 9/64

(52) U.S. Cl. CPC G02B 13/0065; G02B 9/64; G02B 13/0045

(57) ABSTRACT

An optical imaging system includes a first lens, a second lens, a third lens, a fourth lens, a fifth lens, a sixth lens, a seventh lens, and an eighth lens disposed in order from an object side, and an optical path conversion member disposed on an object side of the first lens, wherein a conditional expression 1.3<FNO≤1.5 is satisfied, where FNO is a value (F-number) representing a brightness of the optical imaging system.

### CROSS-REFERENCE TO RELATED APPLICATIONS

This application claims the benefit under 35 USC 119(a) of Korean Patent Application No. 10-2024-0201621 filed on Dec. 31, 2024, in the Korean Intellectual Property Office, the entire disclosure of which is incorporated herein by reference for all purposes.

### BACKGROUND

### 1. Field

The present disclosure relates to an optical imaging system for a wide-angle camera, and more particularly, an optical imaging system for a wide-angle camera including an optical path conversion member.

### 2. Description of the Background

A wide-angle camera may be the most widely used camera among various types of cameras mounted on a mobile device. Accordingly, quality of images obtained by a wide-angle camera may greatly affect performance of a mobile device perceived by a user.

For example, to implement high-quality images, high resolution may be required, and resolution may be increased by reducing an F value or adopting a large-sized image sensor.

However, as the volume of a mobile device is limited, a method of implementing high resolution while reducing an increase in camera size may be necessary.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an optical imaging system includes a first lens, a second lens, a third lens, a fourth lens, a fifth lens, a sixth lens, a seventh lens, and an eighth lens disposed in order from an object side, and an optical path conversion member disposed on an object side of the first lens, wherein a conditional expression 1.3<FNO≤1.5 is satisfied, where FNO is a value (F-number) representing a brightness of the optical imaging system.

At least one of the seventh lens and the eighth lens may be a D-cut lens.

A conditional expression 0.8<OAL/IMH<0.9 may be satisfied, where OAL is a distance on an optical axis from an object-side surface of the first lens to an imaging plane, and IMH is a diagonal length of the imaging plane.

A conditional expression 100°<FOV×IMH/f<120° may be satisfied, where FOV is a field of view of the optical imaging system, IMH is a diagonal length of an imaging plane, and f is a total focal length of the optical imaging system.

A conditional expression 1.1<FNO×(OAL/IMH)≤1.3 may be satisfied, where OAL is a distance on an optical axis from an object-side surface of the first lens to an imaging plane, and IMH is a diagonal length of the imaging plane.

A conditional expression 10<V1−(V6+V7)/2<30 may be satisfied, where V1 is an Abbe number of the first lens, V6 is an Abbe number of the sixth lens, and V7 is an Abbe number of the seventh lens.

A conditional expression 25<V1−V2<45 and 0≤V1−V4<10 may be satisfied, where V1 is an Abbe number of the first lens, V2 is an Abbe number of the second lens, and V4 is an Abbe number of the fourth lens.

A conditional expression 0<f1/f<1 may be satisfied, where f is a total focal length of the optical imaging system, and f1 is a focal length of the first lens.

The first lens, the third lens, and the fourth lens may have positive refractive power, and the second lens and the fifth lens may have negative refractive power.

The seventh lens may have positive refractive power, and an image-side surface of the seventh lens may be convex.

The eighth lens may have negative refractive power, and an image-side surface of the eighth lens may be concave.

In another general aspect, an optical imaging system includes an optical path conversion member, a first lens having positive refractive power, a second lens having negative refractive power, a third lens having refractive power, a fourth lens having refractive power, a fifth lens having negative refractive power, a sixth lens having negative refractive power, a seventh lens having refractive power, and an eighth lens having refractive power, wherein the optical path conversion member changes a traveling path of light incident in a first optical axis direction to a second optical axis direction, wherein the first to eighth lenses are disposed in the second optical axis direction, and wherein a conditional expression 1.20<OAL/f<1.35 is satisfied, where OAL is a distance on a second optical axis from an object-side surface of the first lens to an imaging plane, and f is a total focal length of the optical imaging system.

A conditional expression 2<|f4/f|<4 may be satisfied, where f4 is a focal length of the fourth lens.

The seventh lens may have positive refractive power, and a conditional expression 1<f7/f<2 may be satisfied, where f7 is a focal length of the seventh lens.

The eighth lens may have negative refractive power, and a conditional expression-1<f8/f<0 may be satisfied, where f8 is a focal length of the eighth lens.

A conditional expression 1<|f3/f|/10<5 may be satisfied, where f3 is a focal length of the third lens.

Other features and aspects will be apparent from the following detailed description, the drawings, and the claims.

### BRIEF DESCRIPTION OF DRAWINGS

FIG. 1A is a configuration diagram illustrating an optical imaging system according to a first embodiment of the present disclosure.

FIG. 1B is a graph indicating aberration properties of an optical imaging system according to a first embodiment of the present disclosure.

FIG. 2A is a configuration diagram illustrating an optical imaging system according to a second embodiment of the present disclosure.

FIG. 2B is a graph indicating aberration properties of an optical imaging system according to a second embodiment of the present disclosure.

FIG. 3A is a configuration diagram illustrating an optical imaging system according to a third embodiment of the present disclosure.

FIG. 3B is a graph indicating aberration properties of an optical imaging system according to a third embodiment of the present disclosure.

FIG. 4A is a configuration diagram illustrating an optical imaging system according to a fourth embodiment of the present disclosure.

FIG. 4B is a graph indicating aberration properties of an optical imaging system according to a fourth embodiment of the present disclosure.

FIG. 5A is a configuration diagram illustrating an optical imaging system according to a fifth embodiment of the present disclosure.

FIG. 5B is a graph indicating aberration properties of an optical imaging system according to a fifth embodiment of the present disclosure.

FIG. 6A is a configuration diagram illustrating an optical imaging system according to a sixth embodiment of the present disclosure.

FIG. 6B is a graph indicating aberration properties of an optical imaging system according to a sixth embodiment of the present disclosure.

FIG. 7A is a configuration diagram illustrating an optical imaging system according to a seventh embodiment of the present disclosure.

FIG. 7B is a graph indicating aberration properties of an optical imaging system according to a seventh embodiment of the present disclosure.

FIG. 8A is a configuration diagram illustrating an optical imaging system according to an eighth embodiment of the present disclosure.

FIG. 8B is a graph indicating aberration properties of an optical imaging system according to an eighth embodiment of the present disclosure.

FIG. 9A is a configuration diagram illustrating an optical imaging system according to a ninth embodiment of the present disclosure.

FIG. 9B is a graph indicating aberration properties of an optical imaging system according to a ninth embodiment of the present disclosure.

FIG. 10A is a configuration diagram illustrating an optical imaging system according to a 10th embodiment of the present disclosure.

FIG. 10B is a graph indicating aberration properties of an optical imaging system according to a 10th embodiment of the present disclosure.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

An aspect of the present disclosure is to provide an optical imaging system which may implement high resolution while having a structure less affected by a limitation in thickness of a mobile device.

In the drawings, a thickness, size, and shape of a lens may be exaggerated for ease of description, and a spherical or aspherical shape of a lens is merely an example and is not limited thereto.

In the embodiments, a first lens may indicate the lens closest to an object side, and an eighth lens may indicate the lens closest to an imaging plane (or image sensor).

Also, in the embodiments, a unit of a radius of curvature, thickness, distance, and focal length of a lens may be millimeters (mm), and a unit of field of view may be degrees) (°.

In the description related to the shape of a lens of the embodiments, a convex surface may indicate that a paraxial region (a narrow region in vicinity of and including an optical axis) portion of a surface may be convex, and a concave surface may indicate that a paraxial region portion of the surface may be concave. Accordingly, even when one surface of the lens is described as having a convex shape, an edge portion of the lens may be concave. Similarly, even when one surface of a lens is described as having a concave shape, an edge portion of the lens may be convex.

The optical imaging system according to embodiments may include eight lenses. For example, the optical imaging system may include a first lens, a second lens, a third lens, a fourth lens, a fifth lens, a sixth lens, a seventh lens, and an eighth lens disposed in order from an object side.

However, the optical imaging system according to embodiments may not include only eight lenses, and may further include other components if desired.

The optical imaging system according to embodiments may further include an image sensor configured to convert incident light from a subject into an electrical signal.

Also, for example, the optical imaging system may further include an infrared blocking filter (hereinafter, “filter”) configured to block infrared light incident to the image sensor.

Also, for example, the optical imaging system may further include an optical path conversion member which may change a path of incident light toward the image sensor. For example, the optical path conversion member may be provided as a prism or a mirror having a reflective surface.

Also, the optical imaging system may further include a stop configured to adjust the amount of light. For example, a stop may be disposed between two adjacent optical elements.

The optical imaging system according to embodiments may include a D-cut lens. For example, at least one of the seventh lens and the eighth lens may be a D-cut lens. In embodiments, the D-cut lens may refer to a lens having a shape including an arc portion and a linear portion along an edge.

The optical imaging system according to embodiments may include a lens formed of a plastic material. For example, the entirety of the first to eighth lenses may be formed of a plastic material.

According to embodiments, at least one of the first to eighth lenses may have a shape having an inflection point. For example, at least one of the first to eighth lenses may include an inflection point on at least one of an object-side surface and an image-side surface. The inflection point formed on the lens surface may reduce aberration.

For example, the optical imaging system according to embodiments may include an inflection point on at least one or more of an image-side surface of the third lens, an object-side surface and an image-side surface of the fifth lens, an object-side surface and an image-side surface of the sixth lens, an object-side surface of the seventh lens, and an image-side surface of the eighth lens. The surfaces of the lenses described above may have at least one inflection point. The shapes of the lens surfaces may be illustrated as simply convex or concave in the drawings, without clearly depicting any inflection points. However, the actual shapes of the lens surfaces should be understood based on the radius of curvature corresponding to each embodiment.

Also, at least one lens from the first to eighth lenses may have an aspherical surface. For example, both an object-side surface and an image-side surface of the first to eighth lenses may be aspherical. The aspherical surface of the first to eighth lenses may be represented by equation 1.

$$Z = \frac{c {Y}^{2}}{1 + \sqrt{1 - ( 1 + k ) {c}^{2} {Y}^{2}}} + {AY}^{4} + {BY}^{6} + {CY}^{8} + {DY}^{10} + {EY}^{12} + {FY}^{14} + {GY}^{16} + {HY}^{18} + {JY}^{20} + {LY}^{22} + {MY}^{24} + {NY}^{26} + {OY}^{28} + {PY}^{30} \qquad [ Equation 1 ]$$

In equation 1, c is the curvature of a lens (the inverse of the radius of curvature), K is the conic constant, and Y is the distance from an arbitrary point on an aspherical surface of the lens to the optical axis. Also, constants A to H, J, and L to P are aspheric coefficients, and Z (SAG) is the distance in the optical axis direction between an arbitrary point on the aspherical surface of the lens and an apex of the aspherical surface.

The optical imaging system according to embodiments may have two optical axes. For example, the optical imaging system according to embodiments may have a first optical axis and a second optical axis approximately perpendicular to the first optical axis.

According to embodiments, the first to eighth lenses may be disposed in order from an object side in a second optical axis direction. The optical path conversion member may change a traveling path of light incident to a first optical axis direction to the second optical axis direction. For example, the optical path conversion member may be disposed on an object side of the first lens, and the first optical axis and the second optical axis may intersect approximately at a center of a reflective surface of the optical path conversion member.

The optical imaging system according to embodiments may have a field of view (FOV) range of a wide-angle lens. For example, the optical imaging system according to embodiments may have a field of view greater than 60° and less than 90°.

An optical imaging system according to embodiments may satisfy one or more of conditional expressions as below.

$$100 ° < FOV \times IMH / f < 120 ° \qquad [ Conditional expression 1 ]$$

$$1.3 < FNO \leq 1.5 \qquad [ Conditional expression 2 ]$$

$$0.8 < OAL / IMH < 0.9 \qquad [ Conditional expression 3 ]$$

$$1.1 < FNO \times ( OAL / IMH ) \leq 1.3 \qquad [ Conditional expression 4 ]$$

$$25 < V 1 - V 2 < 45 \qquad [ Conditional expression 5 ]$$

$$0 \leq V 1 - V 4 < 10 \qquad [ Conditional expression 6 ]$$

$$10 < V 1 - ( V 6 + V 7 ) / 2 < 30 \qquad [ Conditional expression 7 ]$$

$$0 < f 1 / f < 1 \qquad [ Conditional expression 8 ]$$

$$- 5 < f 2 / f < - 1 \qquad [ Conditional expression 9 ]$$

$$1 < \vert f 3 / f \vert / 10 < 5 \qquad [ Conditional expression 10 ]$$

$$2 < \vert f 4 / f \vert < 4 \qquad [ Conditional expression 11 ]$$

$$- 5 < f 5 / f < - 3 \qquad [ Conditional expression 12 ]$$

$$1 < \vert f 6 / f \vert / 10 < 10 \qquad [ Conditional expression 13 ]$$

$$1 < f 7 / f < 2 \qquad [ Conditional expression 14 ]$$

$$- 1 < f 8 / f < 0 \qquad [ Conditional expression 15 ]$$

$$- 0.6 < f 1 / f 2 < 0 \qquad [ Conditional expression 16 ]$$

$$0 < f 1 / f 3 < 1. \qquad [ Conditional expression 17 ]$$

$$1.2 < OAL / f < 1.35 \qquad [ Conditional expression 18 ]$$

$$0.1 < BFL / f < 0.3 \qquad [ Conditional expression 19 ]$$

$$0 < D 1 / f < 0.1 \qquad [ Conditional expression 20 ]$$

In the conditional expressions, FOV is a field of view of the optical imaging system, FNO is a value (F-number) representing a brightness of the optical imaging system, IMH is a diagonal length of an imaging plane of the image sensor, OAL is a distance from an object-side surface of the first lens to an imaging plane on a (second) optical axis, BFL is a distance from an image-side surface of the eighth lens to an imaging plane on the (second) optical axis, and D1 is an air gap between the first lens and the second lens (or a distance from an image-side surface of the first lens to an object-side surface of the second lens on the (second) optical axis).

Also, in the conditional expressions, f is a total focal length of the optical imaging system, f1 is a focal length of the first lens, f2 is a focal length of the second lens, f3 is a focal length of the third lens, f4 is a focal length of the fourth lens, f5 is a focal length of the fifth lens, f6 is a focal length of the sixth lens, f7 is a focal length of the seventh lens, and f8 is a focal length of the eighth lens.

Also, in the conditional expressions, V1 is an Abbe number of the first lens, V2 is an Abbe number of the second lens, V4 is an Abbe number of the fourth lens, V6 is an Abbe number of the sixth lens, and V7 is an Abbe number of the seventh lens.

[Conditional expression 1] may be related to a field of view and miniaturization of the optical imaging system. When [Conditional expression 1] is satisfied, the optical imaging system has an appropriate field of view, may reduce distortion aberration, and may be miniaturized. [Conditional expression 2] may be related to a brightness of the optical imaging system. [Conditional expression 3] may be a slim factor related to miniaturization of the optical imaging system. [Conditional expression 4] may be related to a brightness and miniaturization of the optical imaging system. When [Conditional expression 4] is satisfied, the optical imaging system may be miniaturized while having an appropriate brightness.

[Conditional expression 5] to [Conditional expression 7] may be related to a lens material included in the optical imaging system. When [Conditional expression 5] to [Conditional expression 7] are satisfied, chromatic aberration of the optical imaging system may be improved.

[Conditional expression 8] to [Conditional expression 15] are ratios of a focal length of an individual lens to a total focal length of the optical imaging system, and [Conditional expression 16] and [Conditional expression 17] are ratios of a focal length of a second lens or a third lens to a focal length of a first lens of the optical imaging system. When [Conditional expression 8] to [Conditional expression 17] are satisfied, the optical imaging system may effectively correct aberration.

[Conditional expression 18] and [Conditional expression 19] may be related to miniaturization of the optical imaging system, and [Conditional expression 20] may be related to a design condition for reducing chromatic aberration of the optical imaging system.

Below, an optical imaging system according to embodiments will be described.

### First Embodiment

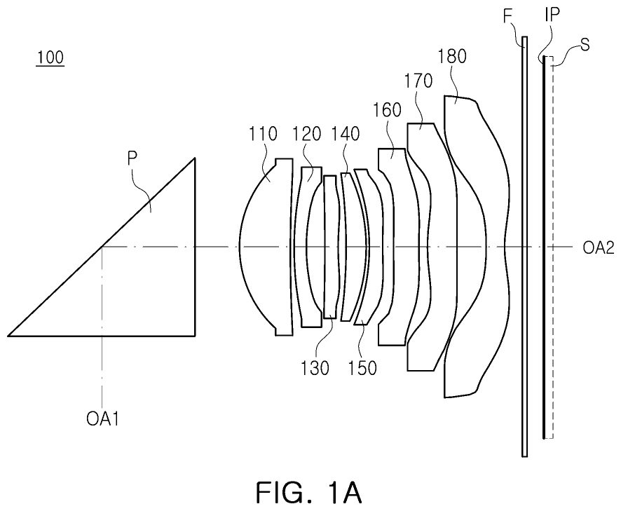

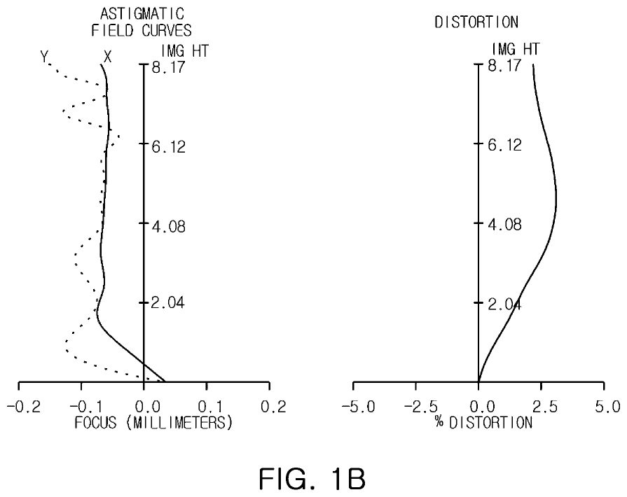

FIG. 1A is a configuration diagram illustrating an optical imaging system according to a first embodiment. FIG. 1B is a graph indicating aberration properties of an optical imaging system according to a first embodiment.

The optical imaging system 100 according to the first embodiment may include a first lens 110, a second lens 120, a third lens 130, a fourth lens 140, a fifth lens 150, a sixth lens 160, a seventh lens 170, and an eighth lens 180.

A prism P may be disposed as an optical path conversion member on an object side of the first lens 110. The prism P may bend a traveling path of light incident in a first optical axis (OA1) direction to a second optical axis (OA2) direction. The first lens 110 to the eighth lens 180 may be disposed in order in the second optical axis (OA2) direction.

A filter F and an image sensor S may be disposed on an image side of the eighth lens 180. Incident light may pass through the first lens 110 to the eighth lens 180 and the filter F in order and may be received at an imaging plane (a plane on which a focus is formed) IP of the image sensor S.

Also, a stop may be disposed between the prism P and the first lens 110. Specifically, the stop may be disposed between an exit surface of the prism P and the first lens 110.

The first lens 110 may have positive refractive power. An object-side surface of the first lens 110 may be convex in a paraxial region, and an image-side surface of the first lens 110 may be concave in a paraxial region.

The second lens 120 may have negative refractive power. An object-side surface of the second lens 120 may be convex in a paraxial region, and an image-side surface of the second lens 120 may be concave in a paraxial region. The second lens 120 may be a high-index lens having a refractive index of 1.6 or more.

The third lens 130 may have positive refractive power. An object-side surface of the third lens 130 may be convex in a paraxial region, and an image-side surface of the third lens 130 may be concave in a paraxial region.

The fourth lens 140 may have positive refractive power. An object-side surface of the fourth lens 140 may be concave in a paraxial region, and an image-side surface of the fourth lens 140 may be convex in a paraxial region.

The fifth lens 150 may have negative refractive power. An object-side surface of the fifth lens 150 may be convex in a paraxial region, and an image-side surface of the fifth lens 150 may be concave in a paraxial region. The fifth lens 150 may be a high-index lens having a refractive index of 1.6 or more.

The sixth lens 160 may have negative refractive power. An object-side surface of the sixth lens 160 may be convex in a paraxial region, and an image-side surface of the sixth lens 160 may be concave in a paraxial region.

The seventh lens 170 may have positive refractive power. An object-side surface and an image-side surface of the seventh lens 170 may be convex in a paraxial region. The seventh lens 170 may be provided as a D-cut lens.

The eighth lens 180 may have negative refractive power. An object-side surface and an image-side surface of the eighth lens 180 may be concave in a paraxial region. The eighth lens 180 may be provided as a D-cut lens.

According to the first embodiment, the prism P may be formed of a glass material, and the first lens 110 to the eighth lens 180 may be formed of a plastic material. Further, object-side surfaces and image-side surfaces of the first lens 110 to the eighth lens 180 may be aspherical.

Table 1 lists characteristics of individual lenses included in the optical imaging system 100 according to the first embodiment, and Table 2 lists aspheric coefficients of individual lenses included in the optical imaging system 100 according to the first embodiment.

TABLE 1

| | | Radius of | | Refractive | Abbe | |
|---|---|---|---|---|---|---|
| Surface No. | Note | curvature | Thickness/distance | index | number | Focal length |
| Object | | Infinity | Infinity | | | |
| 1 | Prism | Infinity | 4.200 | 2.116 | 17.02 | |
| 2 | | Infinity | 4.200 | 2.116 | 17.02 | |
| 3 | | Infinity | 2.000 | | | |
| 4 | Stop | Infinity | 1.630 | | | |
| 5 | First lens | 4.879 | 2.286 | 1.544 | 55.99 | 9.412 |
| 6 | | 80.972 | 0.171 | | | |
| 7 | Second lens | 50.102 | 0.550 | 1.693 | 18.41 | −19.576 |
| 8 | | 10.631 | 0.824 | | | |
| 9 | Third lens | 11.444 | 0.600 | 1.544 | 55.99 | 164.430 |
| 10 | | 12.874 | 0.356 | | | |
| 11 | Fourth lens | −53.100 | 0.899 | 1.544 | 55.99 | 28.881 |
| 12 | | −12.227 | 0.140 | | | |
| 13 | Fifth lens | 78.109 | 0.601 | 1.693 | 18.41 | −38.497 |
| 14 | | 19.830 | 0.490 | | | |
| 15 | Sixth lens | 25.228 | 1.137 | 1.567 | 37.40 | −117.814 |
| 16 | | 18.038 | 0.386 | | | |
| 17 | Seventh | 7.841 | 1.324 | 1.567 | 37.40 | 12.976 |
| | lens | | | | | |
| 18 | | −121.980 | 1.310 | | | |
| 19 | Eighth lens | −21.796 | 0.830 | 1.534 | 55.90 | −7.958 |
| 20 | | 5.381 | 0.800 | | | |
| 21 | Filter | Infinity | 0.210 | 1.517 | 64.20 | |
| 22 | | Infinity | 0.715 | | | |
| Image | | Infinity | | | | |

TABLE 2

| Note | 5 | 6 | 7 | 8 | 9 | 10 | 11 | 12 |
|---|---|---|---|---|---|---|---|---|
| Conic | −0.798 | −53.536 | −67.309 | 5.045 | −85.511 | −75.642 | 99.000 | 0.000 |
| constant | | | | | | | | |
| (K) | | | | | | | | |
| 4th order | −1.808E−01 | −4.613E−02 | −2.474E−01 | −1.053E−01 | 2.836E−01 | 3.702E−01 | 1.595E−01 | 2.493E−01 |
| coefficient | | | | | | | | |
| (A) | | | | | | | | |
| 6th order | 2.425E−02 | 4.763E−02 | −1.943E−02 | −4.499E−02 | 5.030E−03 | −1.226E−02 | −3.349E−03 | 4.396E−02 |
| coefficient | | | | | | | | |
| (B) | | | | | | | | |
| 8th order | 1.311E−02 | −8.946E−03 | −1.837E−02 | −1.452E−02 | −2.240E−02 | −3.236E−02 | −1.698E−03 | −3.761E−03 |
| coefficient | | | | | | | | |
| (C) | | | | | | | | |
| 10th | 4.976E−03 | 6.703E−03 | 7.218E−03 | 2.442E−03 | 1.678E−03 | −3.818E−03 | −3.608E−03 | −2.083E−03 |
| order | | | | | | | | |
| coefficient | | | | | | | | |
| (D) | | | | | | | | |
| 12th | 5.759E−04 | −1.139E−03 | −3.021E−04 | 1.888E−03 | 1.490E−03 | −6.391E−04 | −3.708E−04 | −1.717E−03 |
| order | | | | | | | | |
| coefficient | | | | | | | | |
| (E) | | | | | | | | |
| 14th | 2.760E−04 | 7.282E−04 | 1.306E−03 | 2.229E−03 | 1.845E−03 | 8.766E−04 | 6.596E−04 | 1.069E−03 |
| order | | | | | | | | |
| coefficient | | | | | | | | |
| (F) | | | | | | | | |
| 16th | −1.231E−04 | −2.354E−04 | −6.693E−05 | 1.008E−03 | 5.227E−04 | 1.427E−04 | 2.775E−04 | 1.056E−04 |
| order | | | | | | | | |
| coefficient | | | | | | | | |
| (G) | | | | | | | | |
| 18th | 1.078E−04 | 4.512E−05 | 6.374E−05 | 4.525E−04 | 4.445E−05 | −1.223E−04 | −2.215E−04 | −4.825E−04 |
| order | | | | | | | | |
| coefficient | | | | | | | | |
| (H) | | | | | | | | |
| 20th | −4.074E−05 | −1.847E−05 | −2.651E−05 | 9.484E−05 | −5.844E−05 | −9.604E−05 | −6.047E−06 | 1.531E−05 |
| order | | | | | | | | |
| coefficient | | | | | | | | |
| (J) | | | | | | | | |
| 22nd | 4.319E−05 | 2.062E−05 | 8.649E−06 | 1.476E−06 | −4.181E−05 | −4.542E−05 | −3.420E−05 | −1.954E−05 |
| order | | | | | | | | |
| coefficient | | | | | | | | |
| (L) | | | | | | | | |
| 24th | −5.185E−05 | 1.462E−05 | 1.609E−05 | −2.052E−05 | −1.308E−05 | −3.808E−05 | 1.824E−05 | −8.090E−06 |
| order | | | | | | | | |
| coefficient | | | | | | | | |
| (M) | | | | | | | | |
| 26th | 4.638E−05 | −4.360E−06 | −3.953E−08 | −1.134E−05 | −6.275E−06 | −9.390E−06 | −1.366E−05 | −4.353E−06 |
| order | | | | | | | | |
| coefficient | | | | | | | | |
| (N) | | | | | | | | |
| 28th | 0.000E+00 | 0.000E+00 | 1.350E−06 | −7.896E−06 | 3.695E−06 | −2.283E−06 | 3.020E−05 | −2.257E−05 |
| order | | | | | | | | |
| coefficient | | | | | | | | |
| (O) | | | | | | | | |
| 30th | 0.000E+00 | 0.000E+00 | −2.443E−07 | −1.878E−06 | −3.121E−07 | 1.147E−05 | −5.626E−06 | 1.109E−05 |
| order | | | | | | | | |
| coefficient | | | | | | | | |
| (P) | | | | | | | | |

| Note | 13 | 14 | 15 | 16 | 17 | 18 | 19 | 20 |
|---|---|---|---|---|---|---|---|---|
| Conic | 99.000 | −96.490 | 33.731 | −99.000 | 1.214 | 99.000 | 0.000 | −17.354 |
| constant | | | | | | | | |
| (K) | | | | | | | | |
| 4th order | 7.290E−01 | 8.929E−01 | 8.917E−01 | 1.182E+00 | 2.937E+00 | 8.201E−01 | 1.871E+00 | 3.134E+00 |
| coefficient | | | | | | | | |
| (A) | | | | | | | | |
| 6th order | 2.260E−02 | 2.243E−03 | 6.445E−02 | −3.025E−01 | −1.821E−01 | 5.249E−02 | −1.131E+00 | −6.439E−01 |
| coefficient | | | | | | | | |
| (B) | | | | | | | | |
| 8th order | 7.453E−04 | 5.902E−03 | 5.967E−02 | 4.169E−02 | −9.439E−02 | −7.323E−02 | 3.971E−01 | 9.383E−02 |
| coefficient | | | | | | | | |
| (C) | | | | | | | | |
| 10th | −5.543E−03 | −8.499E−03 | 9.259E−03 | −1.017E−02 | −1.878E−02 | 5.002E−02 | −7.075E−02 | −5.106E−02 |
| order | | | | | | | | |
| coefficient | | | | | | | | |
| (D) | | | | | | | | |
| 12th | −1.556E−03 | −1.356E−03 | 8.366E−03 | 7.926E−03 | 2.510E−02 | −1.241E−02 | −1.448E−02 | 1.461E−02 |
| order | | | | | | | | |
| coefficient | | | | | | | | |
| (E) | | | | | | | | |
| 14th | −4.434E−04 | −2.855E−03 | −2.427E−03 | −9.860E−03 | 5.377E−03 | 2.467E−03 | 4.414E−03 | −6.693E−03 |
| order | | | | | | | | |
| coefficient | | | | | | | | |
| (F) | | | | | | | | |
| 16th | −1.331E−04 | −9.220E−04 | −2.353E−03 | −1.678E−03 | −4.858E−03 | 2.935E−03 | 1.235E−02 | 4.040E−03 |
| order | | | | | | | | |
| coefficient | | | | | | | | |
| (G) | | | | | | | | |
| 18th | −8.481E−04 | −1.036E−03 | −2.629E−03 | 1.006E−03 | −4.999E−03 | −1.433E−04 | −9.754E−03 | −1.544E−03 |
| order | | | | | | | | |
| coefficient | | | | | | | | |
| (H) | | | | | | | | |
| 20th | 8.940E−05 | −6.017E−05 | −1.266E−03 | 2.071E−03 | 5.248E−04 | −1.508E−03 | −4.502E−05 | 4.201E−04 |
| order | | | | | | | | |
| coefficient | | | | | | | | |
| (J) | | | | | | | | |
| 22nd | −9.050E−06 | −1.094E−04 | −6.408E−04 | 4.679E−04 | 1.890E−03 | −1.254E−03 | 1.829E−03 | 2.692E−04 |
| order | | | | | | | | |
| coefficient | | | | | | | | |
| (L) | | | | | | | | |
| 24th | 6.995E−05 | −1.681E−05 | −1.817E−04 | −6.897E−05 | 1.029E−03 | −2.970E−04 | 1.960E−04 | 2.828E−04 |
| order | | | | | | | | |
| coefficient | | | | | | | | |
| (M) | | | | | | | | |
| 26th | 1.601E−05 | 4.465E−06 | 1.866E−05 | −1.401E−04 | 4.014E−05 | 1.504E−04 | −5.480E−04 | 1.490E−04 |
| order | | | | | | | | |
| coefficient | | | | | | | | |
| (N) | | | | | | | | |
| 28th | 1.288E−05 | 1.284E−05 | 8.792E−05 | −4.684E−05 | −1.662E−04 | 7.980E−05 | 4.913E−05 | 7.296E−06 |
| order | | | | | | | | |
| coefficient | | | | | | | | |
| (O) | | | | | | | | |
| 30th | −1.193E−06 | 1.928E−05 | 5.435E−05 | −1.402E−05 | −1.036E−04 | 2.908E−05 | 4.015E−05 | 1.908E−05 |
| order | | | | | | | | |
| coefficient | | | | | | | | |
| (P) | | | | | | | | |

### Second Embodiment

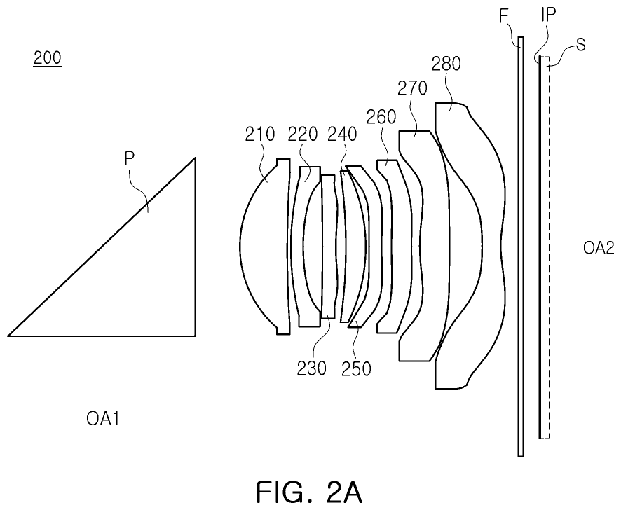

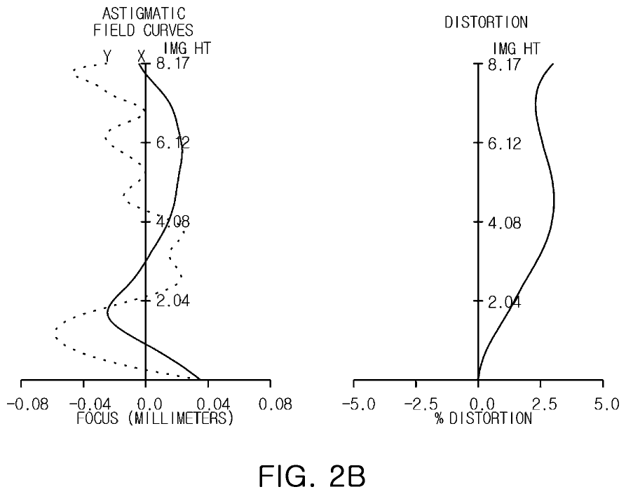

FIG. 2A is a configuration diagram illustrating an optical imaging system according to a second embodiment. FIG. 2B is a graph indicating aberration properties of an optical imaging system according to a second embodiment.

The optical imaging system 200 according to the second embodiment may include a first lens 210, a second lens 220, a third lens 230, a fourth lens 240, a fifth lens 250, a sixth lens 260, a seventh lens 270, and an eighth lens 280.

A prism P may be disposed as an optical path conversion member on an object side of the first lens 210. The prism P may bend a traveling path of light incident in a first optical axis (OA1) direction to a second optical axis (OA2) direction. The first lens 210 to the eighth lens 280 may be disposed in order in the second optical axis (OA2) direction.

A filter F and an image sensor S may be disposed on an image side of the eight lens 280. Incident light may pass through the first lens 210 to the eighth lens 280 and the filter F in order and may be received at an imaging plane IP of the image sensor S.

Also, a stop may be disposed between the prism P and the first lens 210. Specifically, the stop may be disposed between an exit surface of the prism P and the first lens 210.

The first lens 210 may have positive refractive power. An object-side surface of the first lens 210 may be convex in a paraxial region, and an image-side surface of the first lens 210 may be concave in a paraxial region.

The second lens 220 may have negative refractive power. An object-side surface of the second lens 220 may be convex in a paraxial region, and an image-side surface of the second lens 220 may be concave in a paraxial region. The second lens 220 may be a high-index lens having a refractive index of 1.6 or more.

The third lens 230 may have positive refractive power. An object-side surface of the third lens 230 may be convex in a paraxial region, and an image-side surface of the third lens 230 may be concave in a paraxial region.

The fourth lens 240 may have positive refractive power. An object-side surface of the fourth lens 240 may be concave in a paraxial region, and an image-side surface of the fourth lens 240 may be convex in a paraxial region.

The fifth lens 250 may have negative refractive power. An object-side surface of the fifth lens 250 may be convex in a paraxial region, and an image-side surface of the fifth lens 250 may be concave in a paraxial region. The fifth lens 250 may be a high-index lens having a refractive index of 1.6 or more.

The sixth lens 260 may have negative refractive power. An object-side surface of the sixth lens 260 may be convex in a paraxial region, and an image-side surface of the sixth lens 260 may be concave in a paraxial region.

The seventh lens 270 may have positive refractive power. An object-side surface and an image-side surface of the seventh lens 270 may be convex in a paraxial region. The seventh lens 270 may be provided as a D-cut lens.

The eighth lens 280 may have negative refractive power. An object-side surface and an image-side surface of the eighth lens 280 may be concave in a paraxial region. The eighth lens 280 may be provided as a D-cut lens.

According to the second embodiment, the prism P may be formed of a glass material, and the first lens 210 to the eighth lens 280 may be formed of a plastic material. Further, object-side surfaces and image-side surfaces of the first lens 210 to the eighth lens 280 may be aspherical.

Table 3 lists characteristics of individual lenses included in the optical imaging system 200 according to the second embodiment, and Table 4 lists aspheric coefficients of individual lenses included in the optical imaging system 200 according to the second embodiment.

TABLE 3

| | | Radius of | | Refractive | Abbe | |
|---|---|---|---|---|---|---|
| Surface No. | Note | curvature | Thickness/distance | index | number | Focal length |
| Object | | Infinity | Infinity | | | |
| 1 | Prism | Infinity | 4.200 | 2.116 | 17.02 | |
| 2 | | Infinity | 4.200 | 2.116 | 17.02 | |
| 3 | | Infinity | 2.000 | | | |
| 4 | Stop | Infinity | 1.661 | | | |
| 5 | First lens | 4.767 | 2.129 | 1.544 | 55.99 | 9.406 |
| 6 | | 56.154 | 0.167 | | | |
| 7 | Second lens | 37.171 | 0.550 | 1.693 | 18.41 | −19.713 |
| 8 | | 9.932 | 0.864 | | | |
| 9 | Third lens | 10.205 | 0.600 | 1.544 | 55.99 | 206.870 |
| 10 | | 10.986 | 0.448 | | | |
| 11 | Fourth lens | −43.456 | 0.890 | 1.544 | 55.99 | 30.516 |
| 12 | | −12.128 | 0.148 | | | |
| 13 | Fifth lens | 54.180 | 0.564 | 1.693 | 18.41 | −39.330 |
| 14 | | 18.062 | 0.444 | | | |
| 15 | Sixth lens | 23.898 | 0.896 | 1.567 | 37.40 | −150.848 |
| 16 | | 18.445 | 0.374 | | | |
| 17 | Seventh | 8.304 | 1.333 | 1.567 | 37.40 | 12.572 |
| | lens | | | | | |
| 18 | | −49.198 | 1.467 | | | |
| 19 | Eighth lens | −20.345 | 0.830 | 1.534 | 55.90 | −7.821 |
| 20 | | 5.362 | 0.800 | | | |
| 21 | Filter | Infinity | 0.210 | 1.517 | 64.20 | |
| 22 | | Infinity | 0.740 | | | |
| Image | | Infinity | | | | |

TABLE 4

| Note | 5 | 6 | 7 | 8 | 9 | 10 | 11 | 12 |
|---|---|---|---|---|---|---|---|---|
| Conic | −0.724 | −89.769 | −11.465 | 4.901 | −87.296 | −69.307 | 99.000 | 0.000 |
| constant | | | | | | | | |
| (K) | | | | | | | | |
| 4th order | −1.820E−01 | −4.060E−02 | −2.539E−01 | −1.279E−01 | 2.757E−01 | 3.617E−01 | 1.444E−01 | 2.535E−01 |
| coefficient | | | | | | | | |
| (A) | | | | | | | | |
| 6th order | 2.026E−02 | 3.944E−02 | −3.079E−02 | −5.362E−02 | 8.356E−03 | −1.312E−02 | −7.683E−03 | 4.087E−02 |
| coefficient | | | | | | | | |
| (B) | | | | | | | | |
| 8th order | 1.394E−02 | −3.246E−03 | −1.114E−02 | −9.359E−03 | −1.933E−02 | −3.069E−02 | −1.810E−02 | −4.685E−03 |
| coefficient | | | | | | | | |
| (C) | | | | | | | | |
| 10th | 5.153E−03 | 4.912E−03 | 4.493E−03 | 2.050E−03 | 3.160E−03 | −2.412E−03 | −2.938E−03 | −1.486E−03 |
| order | | | | | | | | |
| coefficient | | | | | | | | |
| (D) | | | | | | | | |
| 12th | 9.972E−04 | 1.443E−04 | 9.484E−04 | 2.573E−03 | 8.098E−04 | −4.395E−04 | 5.222E−04 | −1.434E−03 |
| order | | | | | | | | |
| coefficient | | | | | | | | |
| (E) | | | | | | | | |
| 14th | 3.393E−04 | 3.667E−04 | 7.475E−04 | 1.794E−03 | 1.209E−03 | 3.961E−04 | 5.087E−04 | 1.426E−03 |
| order | | | | | | | | |
| coefficient | | | | | | | | |
| (F) | | | | | | | | |
| 16th | 2.867E−05 | −5.540E−05 | 2.740E−05 | 7.473E−04 | 4.428E−06 | −2.115E−04 | 3.939E−05 | −4.132E−04 |
| order | | | | | | | | |
| coefficient | | | | | | | | |
| (G) | | | | | | | | |
| 18th | 1.039E−04 | −1.386E−06 | −9.529E−06 | 1.880E−04 | −1.168E−04 | −1.515E−04 | −1.110E−04 | −1.597E−04 |
| order | | | | | | | | |
| coefficient | | | | | | | | |
| (H) | | | | | | | | |
| 20th | −8.000E−07 | 1.885E−05 | 7.422E−07 | −1.959E−05 | −1.467E−04 | −1.404E−04 | −2.758E−05 | −1.524E−04 |
| order | | | | | | | | |
| coefficient | | | | | | | | |
| (J) | | | | | | | | |
| 22nd | 3.116E−05 | 1.090E−05 | 7.153E−06 | −5.671E−05 | −5.259E−05 | −3.910E−05 | −1.648E−05 | 4.450E−05 |
| order | | | | | | | | |
| coefficient | | | | | | | | |
| (L) | | | | | | | | |
| 24th | −1.044E−05 | 2.771E−05 | 2.538E−05 | −2.759E−05 | −1.540E−05 | −3.101E−05 | 4.746E−06 | −5.668E−05 |
| order | | | | | | | | |
| coefficient | | | | | | | | |
| (M) | | | | | | | | |
| 26th | 3.685E−05 | −4.234E−06 | 3.711E−06 | −6.221E−06 | 7.402E−06 | 6.481E−06 | 6.150E−07 | 2.179E−05 |
| order | | | | | | | | |
| coefficient | | | | | | | | |
| (N) | | | | | | | | |
| 28th | −4.438E−06 | −3.521E−06 | −9.146E−07 | 2.894E−06 | 1.028E−05 | −1.380E−06 | 1.657E−05 | −3.211E−05 |
| order | | | | | | | | |
| coefficient | | | | | | | | |
| (O) | | | | | | | | |
| 30th | −3.751E−06 | −6.830E−06 | −8.071E−07 | 1.050E−06 | 1.693E−07 | 1.028E−05 | −1.932E−06 | 1.316E−05 |
| order | | | | | | | | |
| coefficient | | | | | | | | |
| (P) | | | | | | | | |

| Note | 13 | 14 | 15 | 16 | 17 | 18 | 19 | 20 |
|---|---|---|---|---|---|---|---|---|
| Conic | 96.961 | −98.998 | 33.028 | −97.494 | 1.349 | 60.845 | 0.000 | −17.564 |
| constant | | | | | | | | |
| (K) | | | | | | | | |
| 4th order | 7.461E−01 | 8.560E−01 | 8.684E−01 | 1.166E+00 | 3.330E+00 | 3.800E−01 | 2.086E+00 | 3.269E+00 |
| coefficient | | | | | | | | |
| (A) | | | | | | | | |
| 6th order | 2.666E−02 | 1.901E−02 | 5.829E−02 | −2.371E−01 | −4.228E−01 | 1.236E−01 | −1.046E+00 | −5.280E−01 |
| coefficient | | | | | | | | |
| (B) | | | | | | | | |
| 8th order | −6.973E−05 | 1.759E−03 | 5.058E−02 | 2.792E−02 | −1.862E−01 | −2.477E−02 | 3.465E−01 | 6.511E−02 |
| coefficient | | | | | | | | |
| (C) | | | | | | | | |
| 10th | −3.886E−03 | −4.604E−03 | 1.198E−02 | −6.073E−03 | −2.908E−02 | 3.052E−02 | −7.269E−02 | −6.900E−02 |
| order | | | | | | | | |
| coefficient | | | | | | | | |
| (D) | | | | | | | | |
| 12th | −3.353E−03 | −3.436E−03 | 7.761E−03 | −5.336E−03 | −8.029E−03 | −2.490E−03 | −2.488E−02 | 7.574E−03 |
| order | | | | | | | | |
| coefficient | | | | | | | | |
| (E) | | | | | | | | |
| 14th | 3.027E−04 | −1.633E−03 | −7.485E−04 | −4.121E−03 | −9.805E−03 | −1.974E−03 | −2.609E−04 | −8.353E−03 |
| order | | | | | | | | |
| coefficient | | | | | | | | |
| (F) | | | | | | | | |
| 16th | −9.596E−04 | −1.665E−03 | −2.655E−03 | 5.741E−04 | 2.811E−04 | 1.029E−03 | 1.578E−02 | 3.675E−03 |
| order | | | | | | | | |
| coefficient | | | | | | | | |
| (G) | | | | | | | | |
| 18th | −5.635E−04 | −9.310E−04 | −2.436E−03 | 1.798E−03 | −2.348E−03 | 5.473E−04 | −3.594E−03 | −3.868E−04 |
| order | | | | | | | | |
| coefficient | | | | | | | | |
| (H) | | | | | | | | |
| 20th | −1.126E−04 | −1.315E−04 | −8.317E−04 | 4.800E−04 | −6.765E−03 | −4.686E−04 | −8.279E−04 | 6.530E−04 |
| order | | | | | | | | |
| coefficient | | | | | | | | |
| (J) | | | | | | | | |
| 22nd | 1.326E−04 | 3.522E−05 | −1.651E−04 | 4.800E−04 | −6.765E−03 | −4.686E−04 | −9.608E−05 | −4.558E−05 |
| order | | | | | | | | |
| coefficient | | | | | | | | |
| (L) | | | | | | | | |
| 24th | 4.656E−05 | −5.343E−06 | −9.612E−06 | −5.112E−04 | −3.715E−03 | −1.239E−04 | 3.620E−05 | 1.066E−05 |
| order | | | | | | | | |
| coefficient | | | | | | | | |
| (M) | | | | | | | | |
| 26th | 6.186E−05 | 2.487E−05 | 3.250E−05 | −2.092E−04 | 5.781E−04 | 1.213E−04 | −7.529E−05 | 1.320E−04 |
| order | | | | | | | | |
| coefficient | | | | | | | | |
| (N) | | | | | | | | |
| 28th | −1.067E−05 | 1.260E−06 | 4.141E−05 | −5.043E−06 | 1.315E−03 | −4.101E−05 | 8.967E−05 | 9.452E−05 |
| order | | | | | | | | |
| coefficient | | | | | | | | |
| (O) | | | | | | | | |
| 30th | 1.526E−06 | 1.429E−05 | 1.372E−05 | 9.049E−05 | 4.773E−04 | −3.485E−06 | −4.496E−06 | 5.887E−05 |
| order | | | | | | | | |
| coefficient | | | | | | | | |
| (P) | | | | | | | | |

### Third Embodiment

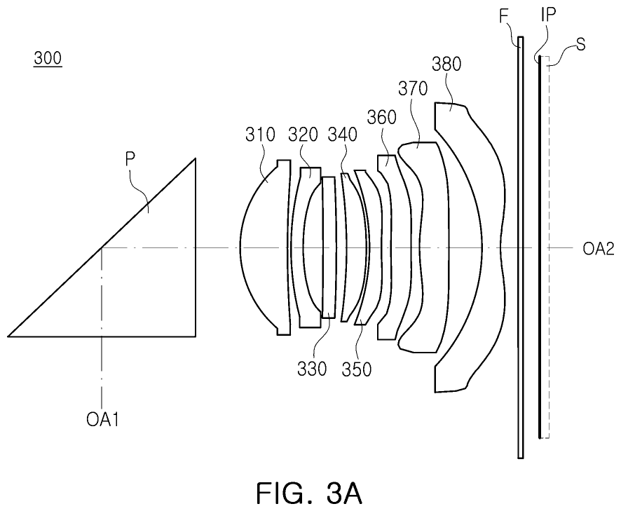

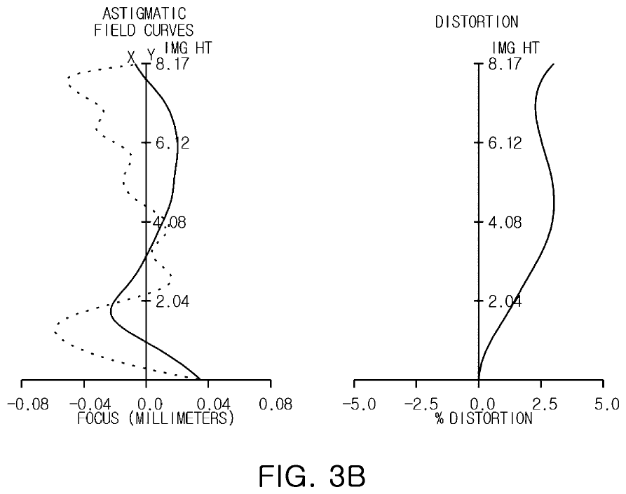

FIG. 3A is a configuration diagram illustrating an optical imaging system according to a third embodiment. FIG. 3B is a graph indicating aberration properties of an optical imaging system according to a third embodiment.

The optical imaging system 300 according to the third embodiment may include a first lens 310, a second lens 320, a third lens 330, a fourth lens 340, a fifth lens 350, a sixth lens 360, a seventh lens 370, and an eighth lens 380.

A prism P may be disposed on an object side of the first lens 310 as an optical path conversion member. The prism P may bend a traveling path of light incident in the first optical axis (OA1) direction to the second optical axis (OA2) direction. The first lens 310 to the eighth lens 380 may be disposed in order in the second optical axis (OA2) direction.

A filter F and an image sensor S may be disposed on an image side of the eight lens 380. Incident light may pass through the first lens 310 to the eighth lens 380 and the filter F in order and may be received at an imaging plane IP of the image sensor S.

Also, a stop may be disposed between the prism P and the first lens 310. Specifically, the stop may be disposed between an exit surface of the prism P and the first lens 310.

The first lens 310 may have positive refractive power. An object-side surface of the first lens 310 may be convex in a paraxial region, and an image-side surface of the first lens 310 may be concave in a paraxial region.

The second lens 320 may have negative refractive power. An object-side surface of the second lens 320 may be convex in a paraxial region, and an image-side surface of the second lens 320 may be concave in a paraxial region. The second lens 320 may be a high-index lens having a refractive index of 1.6 or more.

The third lens 330 may have positive refractive power. An object-side surface of the third lens 330 may be convex in a paraxial region, and an image-side surface of the third lens 330 may be concave in a paraxial region.

The fourth lens 340 may have positive refractive power. An object-side surface of the fourth lens 340 may be concave in a paraxial region, and an image-side surface of the fourth lens 340 may be convex in a paraxial region.

The fifth lens 350 may have negative refractive power. An object-side surface of the fifth lens 350 may be convex in a paraxial region, and an image-side surface of the fifth lens 350 may be concave in a paraxial region. The fifth lens 350 may be a high-index lens having a refractive index of 1.6 or more.

The sixth lens 360 may have negative refractive power. An object-side surface of the sixth lens 360 may be convex in a paraxial region, and an image-side surface of the sixth lens 360 may be concave in a paraxial region.

The seventh lens 370 may have positive refractive power. An object-side surface and an image-side surface of the seventh lens 370 may be convex in a paraxial region. The seventh lens 370 may be provided as a D-cut lens.

The eighth lens 380 may have negative refractive power. An object-side surface and an image-side surface of the eighth lens 380 may be concave in a paraxial region. The eighth lens 380 may be provided as a D-cut lens.

According to the third embodiment, the prism P may be formed of a glass material, and the first lens 310 to the eighth lens 380 may be formed of a plastic material. Further, object-side surfaces and image-side surfaces of the first lens 310 to the eighth lens 380 may be aspherical.

Table 5 lists characteristics of individual lenses included in the optical imaging system 300 according to the third embodiment, and Table 6 lists aspheric coefficients of individual lenses included in the optical imaging system 300 according to the third embodiment.

TABLE 5

| | | Radius of | | Refractive | Abbe | |
|---|---|---|---|---|---|---|
| Surface No. | Note | curvature | Thickness/distance | index | number | Focal length |
| Object | | Infinity | Infinity | | | |
| 1 | Prism | Infinity | 4.200 | 2.116 | 17.02 | |
| 2 | | Infinity | 4.200 | 2.116 | 17.02 | |
| 3 | | Infinity | 2.000 | | | |
| 4 | Stop | Infinity | 1.666 | | | |
| 5 | First lens | 4.742 | 2.123 | 1.544 | 55.99 | 9.414 |
| 6 | | 51.817 | 0.156 | | | |
| 7 | Second lens | 32.740 | 0.550 | 1.693 | 18.41 | −19.722 |
| 8 | | 9.579 | 0.885 | | | |
| 9 | Third lens | 10.165 | 0.600 | 1.544 | 55.99 | 201.724 |
| 10 | | 10.966 | 0.447 | | | |
| 11 | Fourth lens | −42.952 | 0.893 | 1.544 | 55.99 | 30.231 |
| 12 | | −12.008 | 0.130 | | | |
| 13 | Fifth lens | 53.408 | 0.541 | 1.693 | 18.41 | −39.210 |
| 14 | | 17.940 | 0.424 | | | |
| 15 | Sixth lens | 23.736 | 0.902 | 1.567 | 37.40 | −157.674 |
| 16 | | 18.517 | 0.383 | | | |
| 17 | Seventh | 8.285 | 1.316 | 1.567 | 37.40 | 12.569 |
| | lens | | | | | |
| 18 | | −49.849 | 1.476 | | | |
| 19 | Eighth lens | −20.868 | 0.830 | 1.534 | 55.90 | −7.821 |
| 20 | | 5.326 | 0.800 | | | |
| 21 | Filter | Infinity | 0.210 | 1.517 | 64.20 | |
| 22 | | Infinity | 0.739 | | | |
| Image | | Infinity | | | | |

TABLE 6

| Note | 5 | 6 | 7 | 8 | 9 | 10 | 11 | 12 |
|---|---|---|---|---|---|---|---|---|
| Conic | −0.715 | −89.785 | −8.611 | 4.978 | −82.243 | −66.816 | 99.000 | 0.000 |
| constant | | | | | | | | |
| (K) | | | | | | | | |
| 4th order | −1.838E−01 | −4.103E−02 | −2.555E−01 | −1.287E−01 | 2.734E−01 | 3.628E−01 | 1.428E−01 | 2.517E−01 |
| coefficient | | | | | | | | |
| (A) | | | | | | | | |
| 6th order | 1.991E−02 | 3.968E−02 | −3.406E−02 | −5.840E−02 | 6.197E−03 | −1.242E−02 | −7.416E−03 | 4.172E−02 |
| coefficient | | | | | | | | |
| (B) | | | | | | | | |
| 8th order | 1.436E−02 | −3.202E−03 | −1.272E−02 | −1.306E−02 | −2.086E−02 | −3.054E−02 | −1.782E−02 | −5.065E−03 |
| coefficient | | | | | | | | |
| (C) | | | | | | | | |
| 10th | 5.388E−03 | 4.260E−03 | 3.496E−03 | 2.008E−04 | 2.240E−03 | −2.051E−03 | −2.530E−03 | −1.316E−03 |
| order | | | | | | | | |
| coefficient | | | | | | | | |
| (D) | | | | | | | | |
| 12th | 1.010E−03 | 2.318E−04 | 1.081E−03 | 2.269E−03 | 1.129E−03 | 1.199E−04 | 6.435E−04 | −1.563E−03 |
| order | | | | | | | | |
| coefficient | | | | | | | | |
| (E) | | | | | | | | |
| 14th | 2.897E−04 | 3.507E−04 | 8.384E−04 | 2.027E−03 | 1.429E−03 | 5.116E−04 | 4.929E−04 | 1.527E−03 |
| order | | | | | | | | |
| coefficient | | | | | | | | |
| (F) | | | | | | | | |
| 16th | −1.232E−05 | −4.717E−05 | 8.772E−05 | 1.086E−03 | 2.934E−04 | −1.603E−04 | −1.502E−05 | −5.032E−04 |
| order | | | | | | | | |
| coefficient | | | | | | | | |
| (G) | | | | | | | | |
| 18th | 8.580E−05 | 4.922E−06 | 3.713E−05 | 4.779E−04 | 5.737E−05 | −1.345E−04 | −9.241E−05 | −1.194E−04 |
| order | | | | | | | | |
| coefficient | | | | | | | | |
| (H) | | | | | | | | |
| 20th | −7.313E−06 | 1.278E−05 | −4.672E−07 | 1.520E−04 | −1.955E−05 | −1.199E−04 | −2.321E−05 | −1.883E−04 |
| order | | | | | | | | |
| coefficient | | | | | | | | |
| (J) | | | | | | | | |
| 22nd | 2.667E−05 | 7.585E−06 | 6.618E−06 | 3.227E−05 | −1.048E−05 | −4.113E−05 | −3.268E−06 | 6.497E−05 |
| order | | | | | | | | |
| coefficient | | | | | | | | |
| (L) | | | | | | | | |
| 24th | −1.110E−05 | 2.133E−05 | 1.022E−05 | −8.267E−07 | 1.414E−06 | −3.491E−05 | −4.048E−06 | −7.460E−05 |
| order | | | | | | | | |
| coefficient | | | | | | | | |
| (M) | | | | | | | | |
| 26th | 3.515E−05 | −4.897E−06 | −1.254E−06 | −4.149E−06 | −4.363E−06 | −4.234E−06 | −3.599E−06 | 3.137E−05 |
| order | | | | | | | | |
| coefficient | | | | | | | | |
| (N) | | | | | | | | |
| 28th | −4.398E−06 | −3.118E−06 | −6.125E−06 | −6.188E−06 | 4.234E−06 | −3.125E−06 | 5.498E−06 | −3.692E−05 |
| order | | | | | | | | |
| coefficient | | | | | | | | |
| (O) | | | | | | | | |
| 30th | −1.958E−06 | −6.536E−06 | 1.250E−07 | −7.220E−06 | −3.074E−06 | 1.114E−05 | 4.851E−06 | 1.598E−05 |
| order | | | | | | | | |
| coefficient | | | | | | | | |
| (P) | | | | | | | | |

| Note | 13 | 14 | 15 | 16 | 17 | 18 | 19 | 20 |
|---|---|---|---|---|---|---|---|---|
| Conic | 99.000 | −99.000 | 35.012 | −94.551 | 1.365 | 73.362 | 0.000 | −18.038 |
| constant | | | | | | | | |
| (K) | | | | | | | | |
| 4th order | 7.452E−01 | 8.691E−01 | 8.743E−01 | 1.167E+00 | 3.387E+00 | 3.579E−01 | 2.112E+00 | 3.269E+00 |
| coefficient | | | | | | | | |
| (A) | | | | | | | | |
| 6th order | 2.674E−02 | 2.072E−02 | 5.898E−02 | −2.290E−01 | −4.229E−01 | 1.298E−01 | −1.059E+00 | −5.323E−01 |
| coefficient | | | | | | | | |
| (B) | | | | | | | | |
| 8th order | −1.682E−04 | 1.196E−03 | 5.014E−02 | 2.544E−02 | −2.270E−01 | −3.297E−02 | 3.577E−01 | 6.051E−02 |
| coefficient | | | | | | | | |
| (C) | | | | | | | | |
| 10th | −3.866E−03 | −4.695E−03 | 1.289E−02 | −6.282E−03 | −3.466E−02 | 2.799E−02 | −7.593E−02 | −6.634E−02 |
| order | | | | | | | | |
| coefficient | | | | | | | | |
| (D) | | | | | | | | |
| 12th | −2.978E−03 | −3.310E−03 | 7.939E−03 | 4.655E−03 | 2.394E−02 | −2.149E−02 | −2.458E−02 | 9.443E−03 |
| order | | | | | | | | |
| coefficient | | | | | | | | |
| (E) | | | | | | | | |
| 14th | 6.132E−04 | −1.555E−03 | −4.893E−04 | −4.654E−03 | −3.518E−03 | −2.820E−03 | −8.286E−04 | −6.989E−03 |
| order | | | | | | | | |
| coefficient | | | | | | | | |
| (F) | | | | | | | | |
| 16th | −9.272E−04 | −1.771E−03 | −2.301E−03 | −2.934E−03 | −1.215E−02 | −9.441E−04 | 1.599E−02 | 2.695E−03 |
| order | | | | | | | | |
| coefficient | | | | | | | | |
| (G) | | | | | | | | |
| 18th | −5.364E−04 | −8.584E−04 | −1.944E−03 | 6.438E−04 | −2.195E−03 | 1.043E−03 | −3.636E−03 | −7.593E−04 |
| order | | | | | | | | |
| coefficient | | | | | | | | |
| (H) | | | | | | | | |
| 20th | −1.721E−04 | −1.661E−04 | −7.065E−04 | 1.329E−03 | −9.772E−04 | 3.661E−04 | −1.198E−03 | 6.504E−06 |
| order | | | | | | | | |
| coefficient | | | | | | | | |
| (J) | | | | | | | | |
| 22nd | 1.095E−04 | 5.449E−05 | −1.585E−04 | 3.166E−04 | −4.872E−03 | −3.681E−04 | 1.663E−04 | −3.656E−05 |
| order | | | | | | | | |
| coefficient | | | | | | | | |
| (L) | | | | | | | | |
| 24th | 1.248E−05 | −3.346E−05 | −6.692E−05 | −3.661E−04 | −4.764E−03 | −1.487E−04 | 2.243E−04 | 2.319E−05 |
| order | | | | | | | | |
| coefficient | | | | | | | | |
| (M) | | | | | | | | |
| 26th | 5.063E−05 | 2.916E−05 | 1.182E−05 | −1.425E−04 | −1.918E−03 | 6.142E−05 | −1.973E−04 | 2.228E−04 |
| order | | | | | | | | |
| coefficient | | | | | | | | |
| (N) | | | | | | | | |
| 28th | −1.402EE−05 | −8.366E−06 | 3.088E−05 | 5.836E−06 | −2.990E−04 | −2.332E−05 | 4.676E−05 | 1.048E−04 |
| order | | | | | | | | |
| coefficient | | | | | | | | |
| (O) | | | | | | | | |
| 30th | 1.791E−06 | 1.967E−05 | 1.914E−05 | 4.723E−05 | 3.901E−05 | −6.984E−07 | 1.050E−05 | 9.187E−05 |
| order | | | | | | | | |
| coefficient | | | | | | | | |
| (P) | | | | | | | | |

### Fourth Embodiment

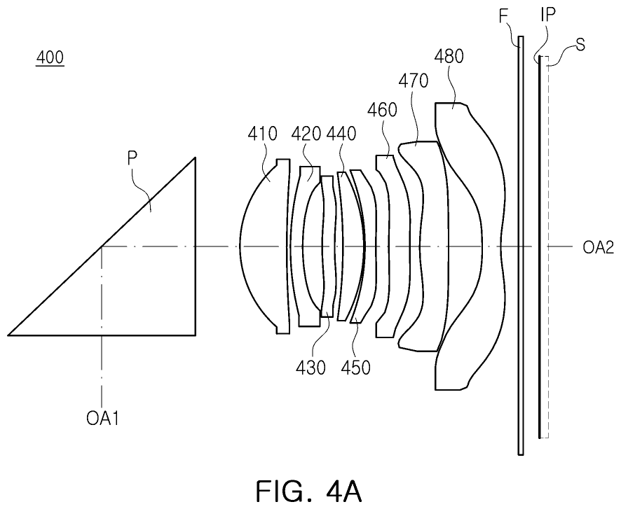

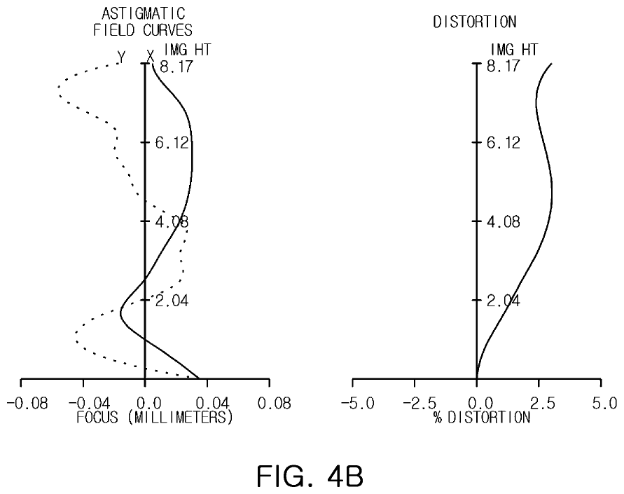

FIG. 4A is a configuration diagram illustrating an optical imaging system according to a fourth embodiment. FIG. 4B is a graph indicating aberration properties of an optical imaging system according to a fourth embodiment.

The optical imaging system 400 according to the fourth embodiment may include a first lens 410, a second lens 420, a third lens 430, a fourth lens 440, a fifth lens 450, a sixth lens 460, a seventh lens 470, and an eighth lens 480.

A prism P may be disposed on an object side of the first lens 410 as an optical path (OA1) direction to a second optical axis (OA2) direction. The first lens 410 to the eighth lens 480 may be disposed in order in the second optical axis (OA2) direction.

A filter F and an image sensor S may be disposed on an image side of the eight lens 480. Incident light may pass through the first lens 410 to the eighth lens 480 and the filter F in order and may be received at an imaging plane IP of the image sensor S.

Also, a stop may be disposed between the prism P and the first lens 410. Specifically, the stop may be disposed between an exit surface of the prism P and the first lens 410.

The first lens 410 may have positive refractive power. An object-side surface of the first lens 410 may be convex in a paraxial region, and an image-side surface of the first lens 410 may be concave in a paraxial region.

The second lens 420 may have negative refractive power. An object-side surface of the second lens 420 may be convex in a paraxial region, and an image-side surface of the second lens 420 may be concave in a paraxial region. The second lens 420 may be a high-index lens having a refractive index of 1.6 or more.

The third lens 430 may have positive refractive power. An object-side surface of the third lens 430 may be convex in a paraxial region, and an image-side surface of the third lens 430 may be concave in a paraxial region.

The fourth lens 440 may have positive refractive power. An object-side surface of the fourth lens 440 may be concave in a paraxial region, and an image-side surface of the fourth lens 440 may be convex in a paraxial region.

The fifth lens 450 may have negative refractive power. An object-side surface of the fifth lens 450 may be convex in a paraxial region, and an image-side surface of the fifth lens 450 may be concave in a paraxial region. The fifth lens 450 may be a high-index lens having a refractive index of 1.6 or more.

The sixth lens 460 may have negative refractive power. An object-side surface of the sixth lens 460 may be convex in a paraxial region, and an image-side surface of the sixth lens 460 may be concave in a paraxial region.

The seventh lens 470 may have positive refractive power. An object-side surface and an image-side surface of the seventh lens 470 may be convex in a paraxial region. The seventh lens 470 may be provided as a D-cut lens.

The eighth lens 480 may have negative refractive power. An object-side surface and an image-side surface of the eighth lens 480 may be concave in a paraxial region. The eighth lens 480 may be provided as a D-cut lens.

According to the fourth embodiment, the prism P may be formed of a glass material, and the first lens 410 to the eighth lens 480 may be formed of a plastic material. Further, object-side surfaces and image-side surfaces of the first lens 410 to the eighth lens 480 may be aspherical.

Table 7 lists characteristics of individual lenses included in the optical imaging system 400 according to the fourth embodiment, and Table 8 lists aspheric coefficients of individual lenses included in the optical imaging system 400 according to the fourth embodiment.

TABLE 7

| | | Radius of | | Refractive | Abbe | |
|---|---|---|---|---|---|---|
| Surface No. | Note | curvature | Thickness/distance | index | number | Focal length |
| Object | | Infinity | Infinity | | | |
| 1 | Prism | Infinity | 4.200 | 2.116 | 17.02 | |
| 2 | | Infinity | 4.200 | 2.116 | 17.02 | |
| 3 | | Infinity | 2.000 | | | |
| 4 | Stop | Infinity | 1.656 | | | |
| 5 | First lens | 4.766 | 2.107 | 1.544 | 55.99 | 9.461 |
| 6 | | 52.216 | 0.163 | | | |
| 7 | Second lens | 33.457 | 0.550 | 1.693 | 18.41 | −19.810 |
| 8 | | 9.672 | 0.870 | | | |
| 9 | Third lens | 10.774 | 0.560 | 1.544 | 55.99 | 259.538 |
| 10 | | 11.447 | 0.371 | | | |
| 11 | Fourth lens | −39.173 | 0.931 | 1.544 | 55.99 | 30.157 |
| 12 | | −11.687 | 0.050 | | | |
| 13 | Fifth lens | 43.749 | 0.495 | 1.693 | 18.41 | −44.222 |
| 14 | | 17.943 | 0.584 | | | |
| 15 | Sixth lens | 23.925 | 0.937 | 1.567 | 37.40 | −181.808 |
| 16 | | 19.161 | 0.451 | | | |
| 17 | Seventh | 8.290 | 1.294 | 1.565 | 41.38 | 12.646 |
| | lens | | | | | |
| 18 | | −50.396 | 1.506 | | | |
| 19 | Eighth lens | −16.989 | 0.830 | 1.534 | 55.90 | −7.675 |
| 20 | | 5.528 | 0.800 | | | |
| 21 | Filter | Infinity | 0.210 | 1.517 | 64.20 | |
| 22 | | Infinity | 0.729 | | | |
| Image | | Infinity | | | | |

TABLE 8

| Note | 5 | 6 | 7 | 8 | 9 | 10 | 11 | 12 |
|---|---|---|---|---|---|---|---|---|
| Conic | −0.700 | −71.543 | −2.894 | 5.095 | −86.565 | −70.636 | 96.898 | 0.000 |
| constant | | | | | | | | |
| (K) | | | | | | | | |
| 4th order | −1.810E−01 | −4.063E−02 | −2.582E−01 | −1.339E−01 | 2.717E−01 | 3.639E−01 | 1.412E−01 | 2.410E−01 |
| coefficient | | | | | | | | |
| (A) | | | | | | | | |
| 6th order | 2.062E−02 | 3.873E−02 | −3.525E−02 | −5.770E−02 | −1.590E−03 | −2.159E−02 | −1.194E−02 | 5.020E−02 |
| coefficient | | | | | | | | |
| (B) | | | | | | | | |
| 8th order | 1.460E−02 | −2.208E−03 | −1.208E−02 | −1.316E−02 | −1.957E−02 | −3.371E−02 | −2.197E−02 | −6.573E−03 |
| coefficient | | | | | | | | |
| (C) | | | | | | | | |
| 10th | 5.590E−03 | 4.006E−03 | 3.141E−03 | 2.357E−06 | 1.690E−03 | −3.487E−03 | −3.181E−03 | −1.312E−03 |
| order | | | | | | | | |
| coefficient | | | | | | | | |
| (D) | | | | | | | | |
| 12th | 1.068E−03 | 2.069E−04 | 9.926E−04 | 2.189E−03 | 1.518E−03 | 2.776E−04 | 8.717E−04 | −1.808E−03 |
| order | | | | | | | | |
| coefficient | | | | | | | | |
| (E) | | | | | | | | |
| 14th | 3.232E−04 | 3.161E−04 | 7.808E−04 | 2.192E−03 | 2.013E−03 | 1.226E−03 | 8.778E−04 | 1.776E−03 |
| order | | | | | | | | |
| coefficient | | | | | | | | |
| (F) | | | | | | | | |
| 16th | −3.081E−05 | 1.248E−07 | 1.315E−04 | 1.310E−03 | 7.301E−04 | 2.965E−04 | 2.100E−04 | −9.333E−04 |
| order | | | | | | | | |
| coefficient | | | | | | | | |
| (G) | | | | | | | | |
| 18th | 9.960E−05 | −3.938E−06 | −7.417E−06 | 6.350E−04 | 2.040E−04 | 6.890E−06 | −5.444E−05 | −3.305E−05 |
| order | | | | | | | | |
| coefficient | | | | | | | | |
| (H) | | | | | | | | |
| 20th | 3.574E−06 | 3.018E−07 | −3.299E−05 | 2.166E−04 | −1.522E−05 | −1.457E−04 | −4.799E−05 | −3.158E−04 |
| order | | | | | | | | |
| coefficient | | | | | | | | |
| (J) | | | | | | | | |
| 22nd | 4.550E−05 | 3.701E−06 | −2.078E−05 | 4.468E−05 | −2.675E−05 | −6.864E−05 | −1.200E−05 | 1.053E−04 |
| order | | | | | | | | |
| coefficient | | | | | | | | |
| (L) | | | | | | | | |
| 24th | −1.356E−05 | 1.358E−05 | −1.818E−06 | −1.552E−05 | −1.561E−05 | −6.129E−05 | −4.824E−06 | −1.020E−04 |
| order | | | | | | | | |
| coefficient | | | | | | | | |
| (M) | | | | | | | | |
| 26th | 2.865E−05 | −3.745E−06 | −7.368E−06 | −1.714E−05 | −1.523E−05 | −1.073E−05 | −2.711E−06 | 3.604E−05 |
| order | | | | | | | | |
| coefficient | | | | | | | | |
| (N) | | | | | | | | |
| 28th | −8.905E−06 | −2.620E−06 | −4.174E−06 | −1.252E−05 | −5.277E−06 | −7.180E−06 | 6.512E−06 | −4.534E−05 |
| order | | | | | | | | |
| coefficient | | | | | | | | |
| (O) | | | | | | | | |
| 30th | 9.278E−07 | −5.725E−06 | −8.597E−07 | −5.172E−06 | −3.648E−06 | 1.586E−05 | 2.812E−06 | 2.118E−05 |
| order | | | | | | | | |
| coefficient | | | | | | | | |
| (P) | | | | | | | | |

| Note | 13 | 14 | 15 | 16 | 17 | 18 | 19 | 20 |
|---|---|---|---|---|---|---|---|---|
| Conic | 43.707 | −99.000 | 38.515 | −78.012 | 0.563 | 76.876 | 0.000 | −21.657 |
| constant | | | | | | | | |
| (K) | | | | | | | | |
| 4th order | 7.746E−01 | 8.332E−01 | 8.456E−01 | 1.185E+00 | 3.139E+00 | 2.989E−01 | 1.885E+00 | 3.079E+00 |
| coefficient | | | | | | | | |
| (A) | | | | | | | | |
| 6th order | 2.760E−02 | 1.912E−02 | 6.375E−02 | −1.950E−01 | −3.739E−01 | 1.059E−01 | −1.024E+00 | −4.636E−01 |
| coefficient | | | | | | | | |
| (B) | | | | | | | | |
| 8th order | −2.493E−03 | 1.588E−03 | 3.865E−02 | 8.539E−03 | −2.284E−01 | −2.751E−02 | 3.611E−01 | 6.399E−02 |
| coefficient | | | | | | | | |
| (C) | | | | | | | | |
| 10th | −6.937E−03 | −5.747E−03 | 1.115E−02 | −4.278E−03 | −4.695E−02 | 1.825E−02 | −8.411E−02 | −6.639E−02 |
| order | | | | | | | | |
| coefficient | | | | | | | | |
| (D) | | | | | | | | |
| 12th | −4.492E−03 | −2.675E−03 | 9.836E−03 | 7.512E−03 | 2.291E−02 | −2.139E−02 | −2.161E−02 | 3.608E−03 |
| order | | | | | | | | |
| coefficient | | | | | | | | |
| (E) | | | | | | | | |
| 14th | −6.011E−05 | −1.398E−03 | 2.736E−03 | −1.659E−03 | 6.050E−03 | 1.159E−03 | 3.824E−03 | −6.613E−03 |
| order | | | | | | | | |
| coefficient | | | | | | | | |
| (F) | | | | | | | | |
| 16th | −1.734E−03 | −1.527E−03 | −1.601E−04 | −3.680E−03 | −6.616E−03 | 2.726E−03 | 1.745E−02 | 1.472E−03 |
| order | | | | | | | | |
| coefficient | | | | | | | | |
| (G) | | | | | | | | |
| 18th | −4.271E−04 | −6.060E−04 | −8.275E−04 | −1.136E−03 | −2.722E−03 | 2.900E−03 | −4.047E−03 | 1.389E−04 |
| order | | | | | | | | |
| coefficient | | | | | | | | |
| (H) | | | | | | | | |
| 20th | −2.481E−04 | −1.930E−04 | −4.755E−04 | 3.161E−04 | −3.559E−03 | 6.726E−04 | −2.2847E−03 | 7.778E−05 |
| order | | | | | | | | |
| coefficient | | | | | | | | |
| (J) | | | | | | | | |
| 22nd | 1.884E−04 | −3.977E−06 | −2.922E−04 | 3.921E−04 | −7.663E−03 | −6.186E−04 | −4.60E−04 | 2.588E−04 |
| order | | | | | | | | |
| coefficient | | | | | | | | |
| (L) | | | | | | | | |
| 24th | 6.009E−06 | −3.416E−05 | −1.921E−04 | −2.116E−05 | −7.628E−03 | −2.964E−04 | 4.201E−04 | −1.540E−04 |
| order | | | | | | | | |
| coefficient | | | | | | | | |
| (M) | | | | | | | | |
| 26th | 6.826E−05 | 1.205E−05 | −1.493E−04 | −4.993E−05 | −4.319E−03 | −6.576E−05 | 3.217E−05 | 1.801E−04 |
| order | | | | | | | | |
| coefficient | | | | | | | | |
| (N) | | | | | | | | |
| 28th | −1.361E−05 | 6.194E−06 | −6.711E−05 | −2.309E−05 | −1.487E−03 | −1.200E−04 | 8.410E−05 | 2.214E−05 |
| order | | | | | | | | |
| coefficient | | | | | | | | |
| (O) | | | | | | | | |
| 30th | 1.104E−05 | 1.591E−05 | −3.599E−05 | 3.131E−05 | −2.642E−04 | −5.060E−05 | −3.538E−05 | 1.098E−04 |
| order | | | | | | | | |
| coefficient | | | | | | | | |
| (P) | | | | | | | | |

### Fifth Embodiment

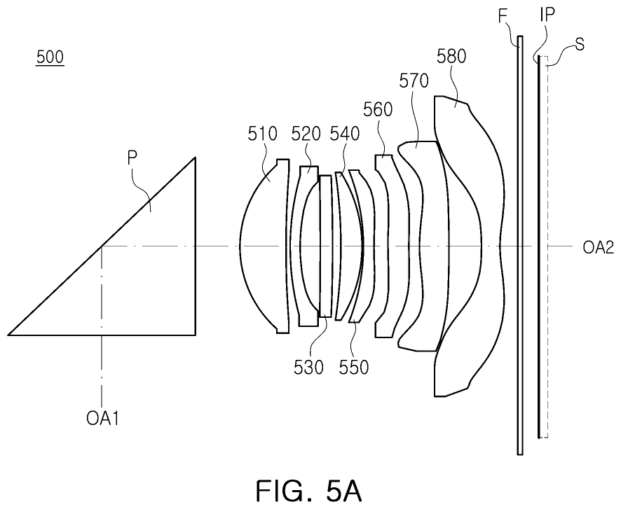

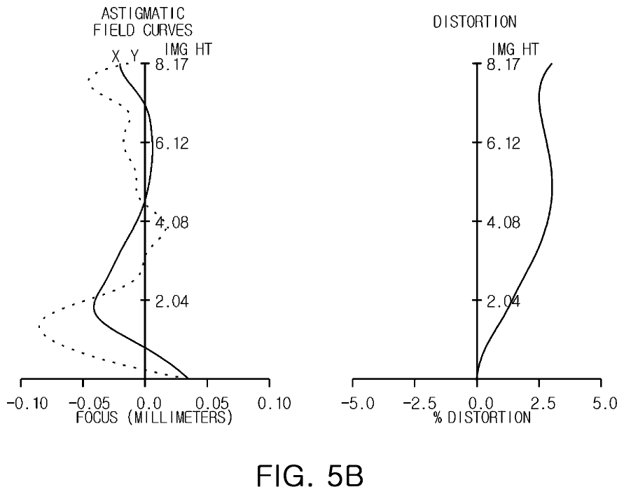

FIG. 5A is a configuration diagram illustrating an optical imaging system according to a fifth embodiment. FIG. 5B is a graph indicating aberration properties of an optical imaging system according to a fifth embodiment.

An optical imaging system 500 according to the fifth embodiment may include a first lens 510, a second lens 520, a third lens 530, a fourth lens 540, a fifth lens 550, a sixth lens 560, a seventh lens 570, and an eighth lens 580.

A prism P may be disposed on an object side of the first lens 510 as an optical path (OA1) direction to a second optical axis (OA2) direction. The first lens 510 to the eighth lens 580 may be disposed in order in the second optical axis (OA2) direction.

A filter F and an image sensor S may be disposed on an image side of the eight lens 580. Incident light may pass through the first lens 510 to the eighth lens 580 and the filter F in order and may be received at an imaging plane IP of the image sensor S.

Also, a stop may be disposed between the prism P and the first lens 510. Specifically, the stop may be disposed between an exit surface of the prism P and the first lens 510.

The first lens 510 may have positive refractive power. An object-side surface of the first lens 510 may be convex in a paraxial region, and an image-side surface of the first lens 510 may be concave in a paraxial region.

The second lens 520 may have negative refractive power. An object-side surface of the second lens 520 may be convex in a paraxial region, and an image-side surface of the second lens 520 may be concave in a paraxial region. The second lens 520 may be a high-index lens having a refractive index of 1.6 or more.

The third lens 530 may have positive refractive power. An object-side surface of the third lens 530 may be convex in a paraxial region, and an image-side surface of the third lens 530 may be concave in a paraxial region.

The fourth lens 540 may have positive refractive power. An object-side surface of the fourth lens 540 may be concave in a paraxial region, and an image-side surface of the fourth lens 540 may be convex in a paraxial region.

The fifth lens 550 may have negative refractive power. An object-side surface of the fifth lens 550 may be convex in a paraxial region, and an image-side surface of the fifth lens 550 may be concave in a paraxial region. The fifth lens 550 may be a high-index lens having a refractive index of 1.6 or more.

The sixth lens 560 may have negative refractive power. An object-side surface of the sixth lens 560 may be convex in a paraxial region, and an image-side surface of the sixth lens 560 may be concave in a paraxial region.

The seventh lens 570 may have positive refractive power. An object-side surface and an image-side surface of the seventh lens 570 may be convex in a paraxial region. The seventh lens 570 may be provided as a D-cut lens.

The eighth lens 580 may have negative refractive power. An object-side surface and an image-side surface of the eighth lens 580 may be concave in a paraxial region. The eighth lens 580 may be provided as a D-cut lens.

According to the fifth embodiment, the prism P may be formed of a glass material, and the first lens 510 to the eighth lens 580 may be formed of a plastic material. Further, object-side surfaces and image-side surfaces of the first lens 510 to the eighth lens 580 may be aspherical.

Table 9 lists characteristics of individual lenses included in the optical imaging system 500 according to the fifth embodiment, and Table 10 lists aspheric coefficients of individual lenses included in the optical imaging system 500 according to the fifth embodiment.

TABLE 9

| | | Radius of | | Refractive | Abbe | |
|---|---|---|---|---|---|---|
| Surface No. | Note | curvature | Thickness/distance | index | number | Focal length |
| Object | | Infinity | Infinity | | | |
| 1 | Prism | Infinity | 4.200 | 2.116 | 17.02 | |
| 2 | | Infinity | 4.200 | 2.116 | 17.02 | |
| 3 | | Infinity | 2.000 | | | |
| 4 | Stop | Infinity | 1.658 | | | |
| 5 | First lens | 4.755 | 2.069 | 1.544 | 55.99 | 9.490 |
| 6 | | 49.076 | 0.186 | | | |
| 7 | Second lens | 32.513 | 0.450 | 1.693 | 18.41 | −20.110 |
| 8 | | 9.703 | 0.901 | | | |
| 9 | Third lens | 10.626 | 0.550 | 1.544 | 55.99 | 259.895 |
| 10 | | 11.277 | 0.373 | | | |
| 11 | Fourth lens | −37.889 | 0.941 | 1.544 | 55.99 | 28.946 |
| 12 | | −7.352 | 0.050 | | | |
| 13 | Fifth lens | 42.355 | 0.490 | 1.693 | 18.41 | −43.855 |
| 14 | | 17.616 | 0.630 | | | |
| 15 | Sixth lens | 23.052 | 0.935 | 1.567 | 37.40 | −210.200 |
| 16 | | 19.047 | 0.476 | | | |
| 17 | Seventh | 8.514 | 1.322 | 1.563 | 42.25 | 12.496 |
| | lens | | | | | |
| 18 | | −39.326 | 1.456 | | | |
| 19 | Eighth lens | −8.653 | 0.830 | 1.534 | 55.90 | −7.481 |
| 20 | | 5.637 | 0.800 | | | |
| 21 | Filter | Infinity | 0.210 | 1.517 | 64.20 | |
| 22 | | Infinity | 0.729 | | | |
| Image | | Infinity | | | | |

TABLE 10

| Note | 5 | 6 | 7 | 8 | 9 | 10 | 11 | 12 |
|---|---|---|---|---|---|---|---|---|
| Conic | −0.681 | −88.490 | 7.276 | 4.931 | −86.662 | −68.930 | 91.217 | 0.000 |
| constant | | | | | | | | |
| (K) | | | | | | | | |
| 4th order | −1.820E−01 | −3.787E−02 | −2.628E−01 | −1.422E−01 | 2.761E−01 | 3.614E−01 | 1.407E−01 | 2.217E−01 |
| coefficient | | | | | | | | |
| (A) | | | | | | | | |
| 6th order | 1.753E−02 | 3.558E−02 | −4.207E−02 | −6.308E−02 | −5.031E−03 | −2.464E−02 | −1.114E−02 | 5.411E−02 |
| coefficient | | | | | | | | |
| (B) | | | | | | | | |
| 8th order | 1.366E−02 | −8.217E−04 | −1.121E−02 | −1.345E−02 | −2.003E−02 | −3.290E−02 | −2.101E−02 | −7.755E−03 |
| coefficient | | | | | | | | |
| (C) | | | | | | | | |
| 10th | 5.404E−03 | 3.721E−03 | 3.351E−03 | −3.918E−04 | 1.498E−03 | −3.994E−03 | −3.903E−03 | −8.467E−04 |
| order | | | | | | | | |
| coefficient | | | | | | | | |
| (D) | | | | | | | | |
| 12th | 1.159E−03 | 3.342E−04 | 1.192E−03 | 2.013E−03 | 1.105E−03 | −4.694E−04 | 3.355E−04 | −2.072E−03 |
| order | | | | | | | | |
| coefficient | | | | | | | | |
| (E) | | | | | | | | |
| 14th | 3.692E−04 | 2.810E−04 | 9.595E−04 | 2.092E−03 | 1.959E−03 | 1.186E−03 | 8.077E−04 | 1.942E−03 |
| order | | | | | | | | |
| coefficient | | | | | | | | |
| (F) | | | | | | | | |
| 16th | 2.892E−07 | 5.769E−05 | 2.366E−04 | 1.370E−03 | 7.641E−04 | 4.168E−04 | 3.050E−04 | −1.124E−03 |
| order | | | | | | | | |
| coefficient | | | | | | | | |
| (G) | | | | | | | | |
| 18th | 8.708E−05 | −1.796E−05 | 3.081E−05 | 6.705E−04 | 2.485E−04 | 1.304E−04 | −4.018E−05 | 5.554E−05 |
| order | | | | | | | | |
| coefficient | | | | | | | | |
| (H) | | | | | | | | |
| 20th | −3.812E−06 | 3.045E−05 | −3.254E−06 | 2.852E−04 | 1.984E−05 | −7.490E−05 | −2.155E−05 | −3.683E−04 |
| order | | | | | | | | |
| coefficient | | | | | | | | |
| (J) | | | | | | | | |
| 22nd | 3.487E−05 | −9.503E−06 | −2.326E−05 | 6.273E−05 | −1.545E−05 | −3.379E−05 | −2.047E−05 | 1.354E−04 |
| order | | | | | | | | |
| coefficient | | | | | | | | |
| (L) | | | | | | | | |
| 24th | −6.226E−06 | 2.787E−05 | 3.897E−06 | 6.147E−06 | −6.814E−06 | −5.582E−05 | 9.063E−07 | −1.321E−04 |
| order | | | | | | | | |
| coefficient | | | | | | | | |
| (M) | | | | | | | | |
| 26th | 2.686E−05 | −8.550E−06 | −1.119E−05 | −1.936E−05 | −1.110E−05 | −9.833E−06 | −7.062E−06 | 5.336E−05 |
| order | | | | | | | | |
| coefficient | | | | | | | | |
| (N) | | | | | | | | |
| 28th | −2.190E−06 | 4.693E−06 | −2.693E−06 | −9.395E−06 | −4.162E−07 | −1.277E−05 | 1.114E−05 | −5.905E−05 |
| order | | | | | | | | |
| coefficient | | | | | | | | |
| (O) | | | | | | | | |
| 30th | −2.821E−06 | −6.550E−06 | 2.547E−07 | −9.422E−06 | −5.246E−06 | 1.333E−05 | 1.511E−06 | 2.600E−05 |
| order | | | | | | | | |
| coefficient | | | | | | | | |
| (P) | | | | | | | | |

| Note | 13 | 14 | 15 | 16 | 17 | 18 | 19 | 20 |
|---|---|---|---|---|---|---|---|---|
| Conic | 36.724 | −99.000 | 31.925 | −69.223 | 0.613 | 6.223 | 0.000 | −22.791 |
| constant | | | | | | | | |
| (K) | | | | | | | | |
| 4th order | 7.757E−01 | 8.392E−01 | 8.431E−01 | 1.202E+00 | 3.075E+00 | 3.807E−01 | 1.704E+00 | 3.031E+00 |
| coefficient | | | | | | | | |
| (A) | | | | | | | | |
| 6th order | 2.855E−02 | 1.862E−02 | 6.342E−02 | −1.814E−01 | −3.544E−01 | 9.251E−02 | −1.005E+00 | −4.734E−01 |
| coefficient | | | | | | | | |
| (B) | | | | | | | | |
| 8th order | −1.735E−03 | 2.347E−03 | 3.501E−02 | 5.911E−03 | −2.153E−01 | −1.812E−02 | 3.538E−01 | 6.848E−02 |
| coefficient | | | | | | | | |
| (C) | | | | | | | | |
| 10th | −5.831E−03 | −5.849E−03 | 7.665E−03 | −5.964E−03 | −5.020E−02 | 2.729E−02 | −7.785E−02 | −7.236E−02 |
| order | | | | | | | | |
| coefficient | | | | | | | | |
| (D) | | | | | | | | |
| 12th | −4.565E−03 | −3.149E−03 | 7.600E−03 | 6.375E−03 | 1.491E−02 | −2.016E−02 | −2.093E−02 | 9.043E−04 |
| order | | | | | | | | |
| coefficient | | | | | | | | |
| (E) | | | | | | | | |
| 14th | −5.713E−05 | −1.591E−03 | 2.157E−03 | −1.138E−03 | 8.753E−03 | −8.569E−04 | 2.375E−03 | −6.445E−03 |
| order | | | | | | | | |
| coefficient | | | | | | | | |
| (F) | | | | | | | | |
| 16th | −1.956E−03 | −1.602E−03 | −1.636E−04 | −3.508E−03 | −1.204E−03 | 6.557E−04 | 1.553E−02 | 1.722E−03 |
| order | | | | | | | | |
| coefficient | | | | | | | | |
| (G) | | | | | | | | |
| 18th | −3.666E−04 | −5.529E−04 | −6.239E−04 | −1.011E−03 | −1.489E−03 | 2.258E−03 | −3.395E−03 | 9.314E−04 |
| order | | | | | | | | |
| coefficient | | | | | | | | |
| (H) | | | | | | | | |
| 20th | −3.061E−04 | −1.964E−04 | −2.823E−04 | 3.118E−04 | −6.497E−03 | 6.849E−04 | −1.934E−03 | 2.571E−04 |
| order | | | | | | | | |
| coefficient | | | | | | | | |
| (J) | | | | | | | | |
| 22nd | 1.953E−04 | 3.938E−06 | −9.761E−05 | 4.673E−04 | −1.024E−02 | −3.878E−04 | −4.051E−04 | 5.469E−04 |
| order | | | | | | | | |
| coefficient | | | | | | | | |
| (L) | | | | | | | | |
| 24th | −2.489E−05 | −3.417E−05 | −2.803E−05 | 1.340E−05 | −8.116E−03 | −1.916E−04 | 3.268E−04 | −3.364E−05 |
| order | | | | | | | | |
| coefficient | | | | | | | | |
| (M) | | | | | | | | |
| 26th | 8.067E−05 | 1.943E−05 | −3.424E−05 | −4.550E−05 | −3.666E−03 | 1.541E−05 | 2.739E−05 | 3.339E−04 |
| order | | | | | | | | |
| coefficient | | | | | | | | |
| (N) | | | | | | | | |
| 28th | −2.040E−05 | 3.886E−06 | −2.813E−06 | −4.380E−05 | −9.622E−04 | −6.480E−05 | 1.013E−04 | 6.516E−05 |
| order | | | | | | | | |
| coefficient | | | | | | | | |
| (O) | | | | | | | | |
| 30th | 1.692E−05 | 1.665E−05 | −1.078E−05 | 2.596E−05 | −1.177E−04 | 3.947E−05 | −3.488E−05 | 1.375E−04 |
| order | | | | | | | | |
| coefficient | | | | | | | | |
| (P) | | | | | | | | |

### Sixth Embodiment

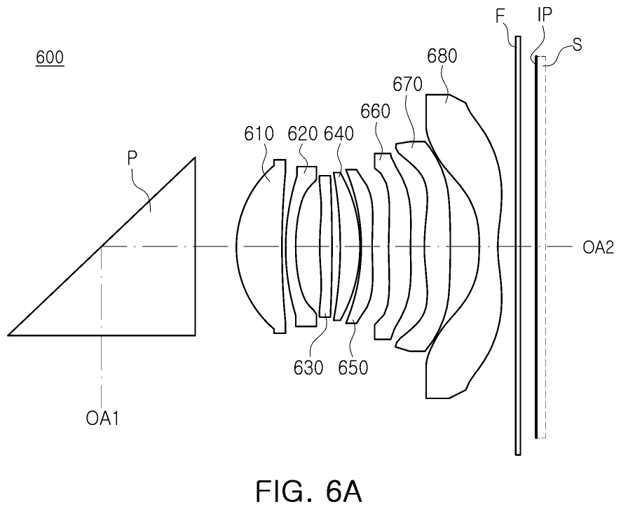

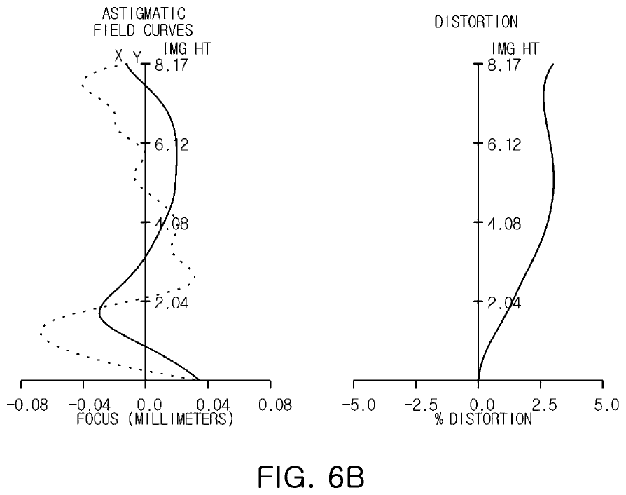

FIG. 6A is a configuration diagram illustrating an optical imaging system according to a sixth embodiment. FIG. 6B is a graph indicating aberration properties of an optical imaging system according to a sixth embodiment.

The optical imaging system 600 according to the sixth embodiment may include a first lens 610, a second lens 620, a third lens 630, a fourth lens 640, a fifth lens 650, a sixth lens 660, a seventh lens 670, and an eighth lens 680.

A prism P may be disposed on an object side of the first lens 610 as an optical path (OA1) direction to a second optical axis (OA2) direction. The first lens 610 to the eighth lens 680 may be disposed in order in the second optical axis (OA2) direction.

A filter F and an image sensor S may be disposed on an image side of the eight lens 680. Incident light may pass through the first lens 610 to the eighth lens 680 and the filter F in order and may be received at an imaging plane IP of the image sensor S.

Also, a stop may be disposed between the prism P and the first lens 610. Specifically, the stop may be disposed between an exit surface of the prism P and the first lens 610.

The first lens 610 may have positive refractive power. An object-side surface of the first lens 610 may be convex in a paraxial region, and an image-side surface of the first lens 610 may be concave in a paraxial region.

The second lens 620 may have negative refractive power. An object-side surface of the second lens 620 may be convex in a paraxial region, and an image-side surface of the second lens 620 may be concave in a paraxial region. The second lens 620 may be a high-index lens having a refractive index of 1.6 or more.

The third lens 630 may have positive refractive power. An object-side surface of the third lens 630 may be convex in a paraxial region, and an image-side surface of the third lens 630 may be concave in a paraxial region.

The fourth lens 640 may have positive refractive power. An object-side surface of the fourth lens 640 may be concave in a paraxial region, and an image-side surface of the fourth lens 640 may be convex in a paraxial region.

The fifth lens 650 may have negative refractive power. An object-side surface of the fifth lens 650 may be convex in a paraxial region, and an image-side surface of the fifth lens 650 may be concave in a paraxial region. The fifth lens 650 may be a high-index lens having a refractive index of 1.6 or more.

The sixth lens 660 may have positive refractive power. An object-side surface of the sixth lens 660 may be convex in a paraxial region, and an image-side surface of the sixth lens 660 may be concave in a paraxial region.

The seventh lens 670 may have positive refractive power. An object-side surface and an image-side surface of the seventh lens 670 may be convex in a paraxial region. The seventh lens 670 may be provided as a D-cut lens.

The eighth lens 680 may have negative refractive power. An object-side surface and an image-side surface of the eighth lens 680 may be concave in a paraxial region. The eighth lens 680 may be provided as a D-cut lens.

According to the sixth embodiment, the prism P may be formed of a glass material, and the first lens 610 to the eighth lens 680 may be formed of a plastic material. Further, object-side surfaces and image-side surfaces of the first lens 610 to the eighth lens 680 may be aspherical.

Table 11 lists characteristics of individual lenses included in the optical imaging system 600 according to the sixth embodiment, and Table 12 lists aspheric coefficients of individual lenses included in the optical imaging system 600 according to the sixth embodiment.

TABLE 11

| Sur- | | | Thick- | Refrac- | Abbe | |
|---|---|---|---|---|---|---|
| face | | Radius of | ness/dis- | tive | num- | Focal |
| No. | Note | curvature | tance | index | ber | length |
| Object | | Infinity | Infinity | | | |
| 1 | Prism | Infinity | 4.200 | 2.116 | 17.02 | |
| 2 | | Infinity | 4.200 | 2.116 | 17.02 | |
| 3 | | Infinity | 2.000 | | | |
| 4 | Stop | Infinity | 1.691 | | | |
| 5 | First lens | 4.678 | 2.046 | 1.544 | 55.99 | 9.542 |
| 6 | | 38.845 | 0.165 | | | |
| 7 | Second lens | 25.481 | 0.450 | 1.693 | 18.41 | −20.780 |
| 8 | | 9.137 | 0.923 | | | |
| 9 | Third lens | 11.113 | 0.550 | 1.544 | 55.99 | 275.210 |
| 10 | | 11.791 | 0.368 | | | |
| 11 | Fourth lens | −31.119 | 0.885 | 1.544 | 55.99 | 26.121 |
| 12 | | −9.875 | 0.050 | | | |
| 13 | Fifth lens | 47.272 | 0.499 | 1.693 | 18.41 | −39.297 |
| 14 | | 17.209 | 0.744 | | | |
| 15 | Sixth lens | 21.457 | 0.983 | 1.567 | 37.40 | 362.476 |
| 16 | | 23.546 | 0.616 | | | |
| 17 | Seventh lens | 9.362 | 1.168 | 1.566 | 40.74 | 12.989 |
| 18 | | −33.463 | 1.296 | | | |
| 19 | Eighth lens | −11.217 | 0.830 | 1.534 | 55.90 | −7.139 |
| 20 | | 5.967 | 0.800 | | | |
| 21 | Filter | Infinity | 0.210 | 1.517 | 64.20 | |
| 22 | | Infinity | 0.715 | | | |
| Image | | Infinity | | | | |

TABLE 12

| Note | 5 | 6 | 7 | 8 | 9 | 10 | 11 | 12 |
|---|---|---|---|---|---|---|---|---|
| Conic | −0.637 | −53.685 | 5.890 | 4.325 | −82.818 | −69.065 | 83.645 | 0.000 |
| constant | | | | | | | | |
| (K) | | | | | | | | |
| 4th order | −1.845E−01 | −4.027E−02 | −2.636E−01 | −1.453E−01 | 2.596E−01 | 3.604E−01 | 1.338E−01 | 1.835E−01 |
| coefficient | | | | | | | | |
| (A) | | | | | | | | |
| 6th order | 1.926E−02 | 3.494E−02 | −5.489E−02 | −7.461E−02 | −2.146E−02 | −3.553E−02 | −1.009E−02 | 5.874E−02 |
| coefficient | | | | | | | | |
| (B) | | | | | | | | |
| 8th order | 1.513E−02 | 2.288E−03 | −7.272E−03 | −1.340E−02 | −1.577E−02 | −3.110E−02 | −2.497E−02 | −7.924E−03 |
| coefficient | | | | | | | | |
| (C) | | | | | | | | |
| 10th order | 6.124E−03 | 3.050E−03 | 2.194E−03 | −9.497E−04 | 3.651E−03 | −1.960E−03 | −4.391E−03 | −1.898E−04 |
| coefficient | | | | | | | | |
| (D) | | | | | | | | |
| 12th order | 1.319E−03 | 7.517E−04 | 1.884E−03 | 2.331E−03 | 1.958E−03 | −1.434E−04 | −5.027E−04 | −1.991E−03 |
| coefficient | | | | | | | | |
| (E) | | | | | | | | |
| 14th order | 4.427E0−4 | 2.172E−04 | 7.999E−04 | 2.117E−03 | 1.954E−03 | 1.068E−03 | 5.787E−04 | 2.237E−03 |
| coefficient | | | | | | | | |
| (F) | | | | | | | | |
| 16th order | 1.266E−05 | 2.560E−05 | 1.963E−04 | 12.303E−03 | 7.808E−04 | 4.449E−04 | 2.737E−04 | −1.267E−03 |
| coefficient | | | | | | | | |
| (G) | | | | | | | | |
| 18th order | 1.050E−04 | 1.303E−05 | 2.468E−05 | 6.213E−04 | 3.122E−04 | 2.183E−04 | 7.407E−05 | 2.887E−04 |
| coefficient | | | | | | | | |
| (H) | | | | | | | | |
| 20th order | −5.295E−06 | 2.248E−05 | 3.756E−06 | 2.425E−04 | 5.081E−05 | −4.086E−05 | −4.071E−06 | −3.835E−04 |
| coefficient | | | | | | | | |
| (J) | | | | | | | | |
| 22nd order | 4.418E−05 | 1.087E−05 | 8.956E−07 | 5.943E−05 | −8.048E−06 | −4.143E−05 | −3.193E−05 | 1.596E−04 |
| coefficient | | | | | | | | |
| (L) | | | | | | | | |
| 24th order | −4.431E−06 | 2.368E−05 | 1.806E−05 | 8.003E−06 | −2.406E−05 | −5.970E−05 | −5.289E−06 | −9.884E−09 |
| coefficient | | | | | | | | |
| (M) | | | | | | | | |
| 26th order | 2.852E−05 | −5.459E−07 | 4.285E−07 | −1.118E−05 | −2.588E−05 | −1.445E−05 | 2.268E−06 | 6.031E−05 |
| coefficient | | | | | | | | |
| (N) | | | | | | | | |
| 28th order | −8.351E−06 | 1.516E−06 | 1.493E−06 | −1.011E−05 | −1.290E−05 | −1.066E−05 | 1.793E−05 | −5.386E−05 |
| coefficient | | | | | | | | |
| (O) | | | | | | | | |
| 30th order | −1.878E−06 | −3.052E−07 | 2.227E−06 | −8.617E−06 | 5.595E−07 | 1.220E−05 | −2.770E−06 | 1.785E−05 |
| coefficient | | | | | | | | |
| (P) | | | | | | | | |
| Note | 13 | 14 | 15 | 16 | 17 | 18 | 19 | 20 |
| Conic | −16.685 | −94.488 | 22.146 | −32.324 | −2.349 | 27.788 | 0.000 | −22.207 |
| constant | | | | | | | | |
| (K) | | | | | | | | |
| 4th order | 7.521E−01 | 8.459E−01 | 9.381E−01 | 1.393E+00 | 2.928E+00 | 9.069E−01 | 1.643E+00 | 3.013E+00 |
| coefficient | | | | | | | | |
| (A) | | | | | | | | |
| 6th order | 3.127E−02 | 1.688E−02 | 8.135E−02 | −1.816E−01 | −2.409E−01 | 5.689E−02 | −1.039E+00 | −5.030E−01 |
| coefficient | | | | | | | | |
| (B) | | | | | | | | |
| 8th order | 5.308E−03 | 6.544E−03 | 3.676E−02 | −3.486E−03 | −2.269E−01 | −4.660E−02 | 3.211E−01 | 9.568E−02 |
| coefficient | | | | | | | | |
| (C) | | | | | | | | |
| 10th order | −2.025E−03 | −3.912E−03 | 7.937E−03 | −1.294E−02 | −6.542E−02 | 3.605E−02 | −5.533E−02 | −6.978E−02 |
| coefficient | | | | | | | | |
| (D) | | | | | | | | |
| 12th order | −2.386E−03 | −1.896E−03 | 7.502E−03 | 4.657E−03 | 1.372E−02 | −1.674E−02 | −2.331E−02 | 9.190E−03 |
| coefficient | | | | | | | | |
| (E) | | | | | | | | |
| 14th order | 6.508E−04 | −1.657E−03 | 9.766E−05 | −4.562E−03 | 1.430E−02 | −3.033E−03 | 2.772E−03 | −8.456E−03 |
| coefficient | | | | | | | | |
| (F) | | | | | | | | |
| 16th order | −2.029E−03 | −1.729E−03 | −2.020E−03 | −4.522E−03 | 2.429E−03 | 2.755E−03 | 1.845E−02 | 2.345E−03 |
| coefficient | | | | | | | | |
| (G) | | | | | | | | |
| 18th order | −2.810E−04 | −5.581E−04 | −1.891E−03 | −1.025E−03 | 4.723E−05 | 2.899E−03 | −6.439E−03 | −1.237E−03 |
| coefficient | | | | | | | | |
| (H) | | | | | | | | |
| 20th order | −4.152E−04 | −2.418E−04 | −9.085E−04 | 8.574E−04 | −2.752E−03 | 6.417E−05 | −4.153E−03 | 8.925E−05 |
| coefficient | | | | | | | | |
| (J) | | | | | | | | |
| 22nd order | 1.416E−04 | −1.360E−05 | −3.438E−04 | 8.264E−04 | −7.155E−03 | −1.082E−03 | 1.201E−03 | 2.992E−04 |
| coefficient | | | | | | | | |
| (L) | | | | | | | | |
| 24th order | −2.294E−05 | −3.073E−05 | −5.862E−05 | 2.029E−04 | −8.061E−03 | −8.928E−04 | 1.242E−03 | 1.623E−04 |
| coefficient | | | | | | | | |
| (M) | | | | | | | | |
| 26th order | 7.740E−05 | 1.715E−05 | 1.286E−05 | −3.745E−05 | −5.127E−03 | −1.509E−04 | −2.415E−04 | 1.995E−04 |
| coefficient | | | | | | | | |
| (N) | | | | | | | | |
| 28th order | −1.172E−05 | −3.844E−06 | 5.428E−05 | −5.559E−05 | −1.913E−03 | 1.216E−04 | −1.080E−04 | 4.928E−05 |
| coefficient | | | | | | | | |
| (O) | | | | | | | | |
| 30th order | 9.020E−06 | 1.946E−05 | 1.894E−05 | −3.816E−06 | −3.905E−04 | 5.112E−05 | −3.691E−06 | 7.673E−05 |
| coefficient | | | | | | | | |
| (P) | | | | | | | | |

### Seventh Embodiment

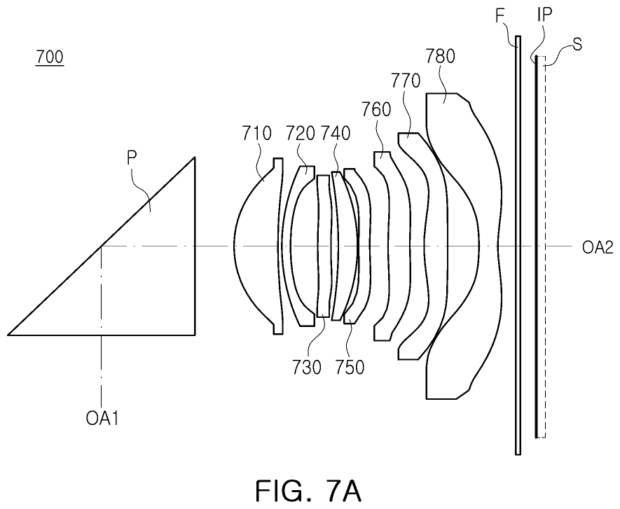

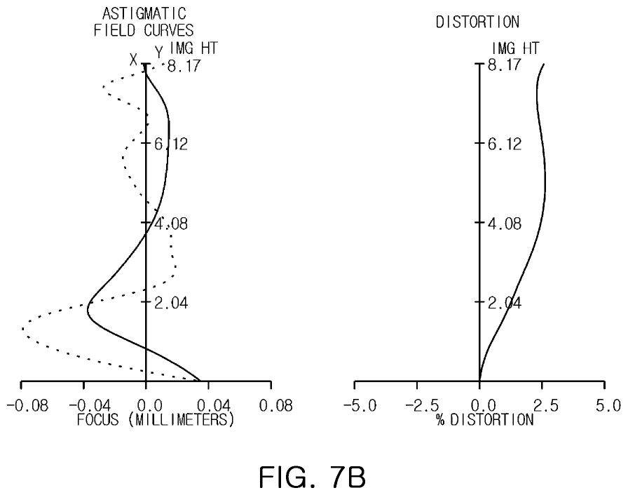

FIG. 7A is a configuration diagram illustrating an optical imaging system according to a seventh embodiment. FIG. 7B is a graph indicating aberration properties of an optical imaging system according to a seventh embodiment.

An optical imaging system 700 according to the seventh embodiment may include a first lens 710, a second lens 720, a third lens 730, a fourth lens 740, a fifth lens 750, a sixth lens 760, a seventh lens 770, and an eighth lens 780.

A prism P may be disposed on an object side of the first lens 710 as an optical path (OA1) direction to a second optical axis (OA2) direction. The first lens 710 to the eighth lens 780 may be disposed in order in the second optical axis (OA2) direction.

A filter F and an image sensor S may be disposed on an image side of the eight lens 780. Incident light may pass through the first lens 710 to the eighth lens 780 and the filter F in order and may be received at an imaging plane IP of the image sensor S.

Also, a stop may be disposed between the prism P and the first lens 710. Specifically, the stop may be disposed between an exit surface of the prism P and the first lens 710.

The first lens 710 may have positive refractive power. An object-side surface of the first lens 710 may be convex in a paraxial region, and an image-side surface of the first lens 710 may be concave in a paraxial region.

The second lens 720 may have negative refractive power. An object-side surface of the second lens 720 may be convex in a paraxial region, and an image-side surface of the second lens 720 may be concave in a paraxial region. The second lens 720 may be a high-index lens having a refractive index of 1.6 or more.

The third lens 730 may have positive refractive power. An object-side surface of the third lens 730 may be convex in a paraxial region, and an image-side surface of the third lens 730 may be concave in a paraxial region.

The fourth lens 740 may have positive refractive power. An object-side surface of the fourth lens 740 may be concave in a paraxial region, and an image-side surface of the fourth lens 740 may be convex in a paraxial region.

The fifth lens 750 may have negative refractive power. An object-side surface of the fifth lens 750 may be convex in a paraxial region, and an image-side surface of the fifth lens 750 may be concave in a paraxial region. The fifth lens 750 may be a high-index lens having a refractive index of 1.6 or more.

The sixth lens 760 may have negative refractive power. An object-side surface of the sixth lens 760 may be convex in a paraxial region, and an image-side surface of the sixth lens 760 may be concave in a paraxial region.

The seventh lens 770 may have positive refractive power. An object-side surface and an image-side surface of the seventh lens 770 may be convex in a paraxial region. The seventh lens 770 may be provided as a D-cut lens.

The eighth lens 780 may have negative refractive power. An object-side surface and an image-side surface of the eighth lens 780 may be concave in a paraxial region. The eighth lens 780 may be provided as a D-cut lens.

According to the seventh embodiment, the prism P may be formed of a glass material, and the first lens 710 to the eighth lens 780 may be formed of a plastic material. Further, object-side surfaces and image-side surfaces of the first lens 710 to the eighth lens 780 may be aspherical.

Table 13 lists characteristics of individual lenses included in the optical imaging system 700 according to the seventh embodiment, and Table 14 lists aspheric coefficients of individual lenses included in the optical imaging system 700 according to the seventh embodiment.

TABLE 13

| | | | Thick- | | | |
|---|---|---|---|---|---|---|
| Sur- | | | ness/ | Refrac- | Abbe | |
| face | | Radius of | dis- | tive | num- | Focal |
| No. | Note | curvature | tance | index | ber | length |
| Object | | Infinity | Infinity | | | |
| 1 | Prism | Infinity | 4.200 | 2.116 | 17.02 | |
| 2 | | Infinity | 4.200 | 2.116 | 17.02 | |
| 3 | | Infinity | 2.000 | | | |
| 4 | Stop | Infinity | 1.780 | | | |
| 5 | First lens | 4.614 | 1.973 | 1.544 | 55.99 | 9.750 |
| 6 | | 29.449 | 0.168 | | | |
| 7 | Second lens | 21.611 | 0.392 | 1.693 | 18.41 | −22.233 |
| 8 | | 8.930 | 0.976 | | | |
| 9 | Third lens | 15.995 | 0.594 | 1.544 | 55.99 | 262.744 |
| 10 | | 17.767 | 0.332 | | | |
| 11 | Fourth lens | −29.361 | 0.865 | 1.544 | 55.99 | 31.055 |
| 12 | | −10.858 | 0.050 | | | |
| 13 | Fifth lens | 34.070 | 0.498 | 1.693 | 18.41 | −45.000 |
| 14 | | 16.188 | 0.821 | | | |
| 15 | Sixth lens | 17.626 | 0.977 | 1.567 | 37.40 | −1645.560 |
| 16 | | 16.953 | 0.641 | | | |
| 17 | Seventh lens | 7.822 | 1.058 | 1.564 | 41.94 | 12.425 |
| 18 | | −66.629 | 1.403 | | | |
| 19 | Eighth lens | −11.688 | 0.850 | 1.534 | 55.90 | −7.218 |
| 20 | | 5.939 | 0.800 | | | |
| 21 | Filter | Infinity | 0.210 | 1.517 | 64.20 | |
| 22 | | Infinity | 0.707 | | | |
| Image | | Infinity | | | | |

TABLE 14

| Note | 5 | 6 | 7 | 8 | 9 | 10 | 11 | 12 |
|---|---|---|---|---|---|---|---|---|
| Conic | −0.548 | −33.306 | 0.549 | 3.840 | −85.045 | −53.663 | 74.511 | 0.000 |
| constant | | | | | | | | |
| (K) | | | | | | | | |
| 4th order | −2.058E−01 | −4.455E−02 | −2.575E−01 | −1.695E−01 | 2.610E−01 | 3.464E−01 | 1.228E−01 | 2.130E−01 |
| coefficient | | | | | | | | |
| (A) | | | | | | | | |
| 6th order | 1.492E−02 | 3.058E−02 | −6.546E−02 | −8.330E−02 | −3.567E−02 | −4.452E−02 | −1.923E−03 | 5.958E−02 |
| coefficient | | | | | | | | |
| (B) | | | | | | | | |
| 8th order | 1.872E−02 | 7.930E−03 | −7.148E−03 | −1.842E−02 | −1.455E−02 | −3.099E−02 | −2.629E−02 | −7.371E−03 |
| coefficient | | | | | | | | |
| (C) | | | | | | | | |
| 10th order | 9.110E−03 | 3.006E−03 | −6.349E−05 | −3.706E−03 | 2.576E−03 | −1.598E−03 | −3.823E−03 | −5.082E−04 |
| coefficient | | | | | | | | |
| (D) | | | | | | | | |
| 12th order | 2.898E−03 | 9.693E−04 | 6.529E−04 | 4.074E−04 | 1.575E−03 | −8.372E−04 | −1.442E−03 | −1.872E−03 |
| coefficient | | | | | | | | |
| (E) | | | | | | | | |
| 14th order | 1.016E−03 | 2.681E−04 | 3.925E−04 | 1.146E−03 | 1.384E−03 | 4.639E−04 | 5.128E−06 | 2.307E−03 |
| coefficient | | | | | | | | |
| (F) | | | | | | | | |
| 16th order | 2.143E−04 | 8.597E−05 | 4.969E−05 | 8.355E−04 | 6.469E−04 | 4.094E−04 | 1.988E−04 | −1.683E−03 |
| coefficient | | | | | | | | |
| (G) | | | | | | | | |
| 18th order | 1.482E−04 | −3.538E−05 | −7.352E−05 | 4.222E−04 | 3.077E−04 | 3.907E−04 | 1.878E−04 | 4.061E−04 |
| coefficient | | | | | | | | |
| (H) | | | | | | | | |
| 20th order | 1.588E−05 | 4.549E−05 | −1.573E−05 | 1.747E−04 | 6.328E−05 | 7.742E−05 | 5.613E−05 | −4.473E−04 |
| coefficient | | | | | | | | |
| (J) | | | | | | | | |
| 22nd order | 4.577E−05 | −1.555E−05 | −3.314E−05 | 3.470E−05 | 1.478E−05 | 4.224E−05 | −5.667E−06 | 1.680E−04 |
| coefficient | | | | | | | | |
| (L) | | | | | | | | |
| 24th order | 2.486E−06 | 3.289E−05 | 1.245E−05 | 4.315E−06 | −1.742E−05 | −2.096E−05 | 8.759E−06 | −1.146E−04 |
| coefficient | | | | | | | | |
| (M) | | | | | | | | |
| 26th order | 2.642E−05 | −8.574E−06 | −1.091E−05 | −1.496E−05 | −1.611E−05 | −5.457E−06 | −6.509E−06 | 4.866E−05 |
| coefficient | | | | | | | | |
| (N) | | | | | | | | |
| 28th order | −8.948E−06 | 1.110E−05 | 7.729E−06 | −2.962E−06 | −1.390E−05 | −1.767E−05 | 8.990E−06 | −4.471E−05 |
| coefficient | | | | | | | | |
| (O) | | | | | | | | |
| 30th order | −8.960E−06 | −8.994E−06 | 5.634E−07 | 2.006E−06 | 2.665E−06 | 4.232E−06 | −7.920E−07 | 1.718E−05 |
| coefficient | | | | | | | | |
| (P) | | | | | | | | |
| Note | 13 | 14 | 15 | 16 | 17 | 18 | 19 | 20 |
| Conic | −16.447 | −66.114 | 13.792 | −11.513 | −7.867 | 99.000 | 0.000 | −21.815 |
| constant | | | | | | | | |
| (K) | | | | | | | | |
| 4th order | 7.717E−01 | 8.575E−01 | 1.036E+00 | 1.550E+00 | 2.433E+00 | 1.068E+00 | 1.705E+00 | 2.973E+00 |
| coefficient | | | | | | | | |
| (A) | | | | | | | | |
| 6th order | 3.277E−02 | 2.112E−02 | 9.722E−02 | −1.850E−01 | −6.422E−02 | 6.603E−02 | −1.078E+00 | −5.717E−01 |
| coefficient | | | | | | | | |
| (B) | | | | | | | | |
| 8th order | 3.226E−03 | 1.753E−03 | 3.026E−02 | −5.787E−03 | −1.509E−01 | −7.616E−02 | 3.247E−01 | 1.132E−01 |
| coefficient | | | | | | | | |
| (C) | | | | | | | | |
| 10th order | −9.422E−04 | −1.749E−03 | 6.023E−03 | −1.321E−02 | −3.803E−02 | 3.267E−02 | −5.543E−02 | −7.644E−02 |
| coefficient | | | | | | | | |
| (D) | | | | | | | | |
| 12th order | −1.679E−03 | −1.704E−03 | 5.796E−03 | 5.187E−03 | 6.183E−03 | −8.943E−03 | −9.332E−03 | 1.537E−02 |
| coefficient | | | | | | | | |
| (E) | | | | | | | | |
| 14th order | 9.179E−04 | −1.782E−03 | −1.539E−03 | −4.037E−03 | 3.396E−03 | 1.977E−03 | 7.687E−04 | −1.086E−02 |
| coefficient | | | | | | | | |
| (F) | | | | | | | | |
| 16th order | −2.637E−03 | −2.071E−03 | −2.295E−03 | −2.501E−03 | −1.815E−03 | 5.848E−03 | 1.768E−02 | 4.949E−03 |
| coefficient | | | | | | | | |
| (G) | | | | | | | | |
| 18th order | −2.770E−04 | −4.790E−04 | −1.359E−03 | −8.839E−05 | −1.155E−03 | 1.492E−03 | −7.520E−03 | −1.385E−03 |
| coefficient | | | | | | | | |
| (H) | | | | | | | | |
| 20th order | −5.012E−04 | −2.151E−04 | −1.878E−04 | 8.098E−04 | 2.267E−03 | −4.722E−04 | −3.359E−03 | 1.563E−03 |
| coefficient | | | | | | | | |
| (J) | | | | | | | | |
| 22nd order | 1.204E−04 | −2.061E−05 | 3.673E−05 | 2.801E−04 | 2.224E−03 | −1.051E−03 | 1.221E−03 | 3.873E−04 |
| coefficient | | | | | | | | |
| (L) | | | | | | | | |
| 24th order | −4.912E−05 | −3.247E−05 | 9.574E−05 | −8.336E−05 | 6.828E−04 | −7.489E−04 | 1.186E−03 | 2.951E−04 |
| coefficient | | | | | | | | |
| (M) | | | | | | | | |
| 26th order | 6.057E−05 | 1.576E−05 | 1.618E−05 | −6.830E−05 | −2.221E−04 | −6.087E−05 | −2.424E−04 | 3.723E−05 |
| coefficient | | | | | | | | |
| (N) | | | | | | | | |
| 28th order | −3.537E−06 | 4.085E−06 | 2.392E−05 | −1.337E−05 | −2.879E−04 | 1.097E−04 | −1.336E−04 | −1.931E−06 |
| coefficient | | | | | | | | |
| (O) | | | | | | | | |
| 30th order | 1.366E−05 | 1.703E−05 | −1.518E−05 | 1.838E−05 | −1.248E−04 | 6.426E−05 | 1.134E−05 | 3.535E−05 |
| coefficient | | | | | | | | |
| (P) | | | | | | | | |

### Eighth Embodiment

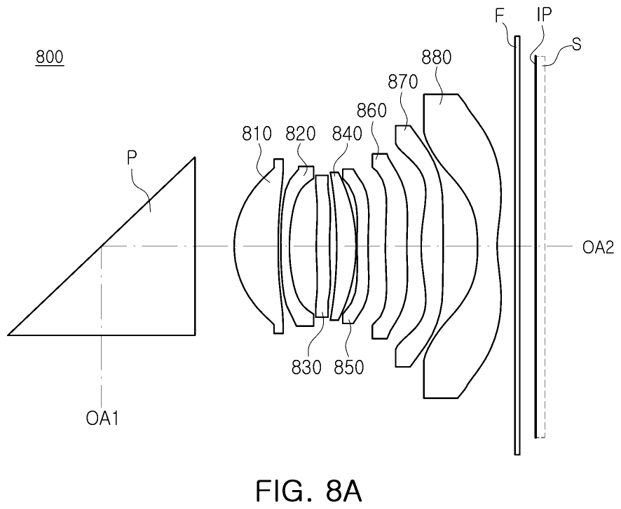

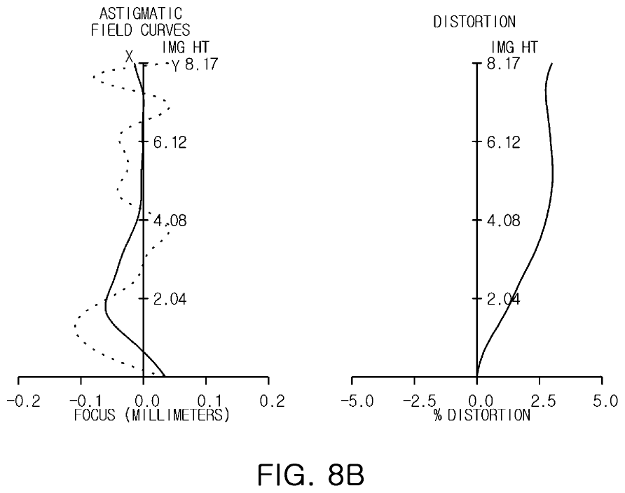

FIG. 8A is a configuration diagram illustrating an optical imaging system according to an eighth embodiment. FIG. 8B is a graph indicating aberration properties of an optical imaging system according to an eighth embodiment.

An optical imaging system 800 according to an eighth embodiment may include a first lens 810, a second lens 820, a third lens 830, a fourth lens 840, a fifth lens 850, a sixth lens 860, a seventh lens 870, and an eighth lens 880.

A prism P may be disposed on an object side of the first lens 810 as an optical path (OA1) direction to a second optical axis (OA2) direction. The first lens 810 to the eighth lens 880 may be disposed in order in the second optical axis (OA2) direction.

A filter F and an image sensor S may be disposed on an image side of the eight lens 880. Incident light may pass through the first lens 810 to the eighth lens 880 and the filter F in order and may be received at an imaging plane IP of the image sensor S.

Also, a stop may be disposed between the prism P and the first lens 810. Specifically, the stop may be disposed between an exit surface of the prism P and the first lens 810.

The first lens 810 may have positive refractive power. An object-side surface of the first lens 810 may be convex in a paraxial region, and an image-side surface of the first lens 810 may be concave in a paraxial region.

The second lens 820 may have negative refractive power. An object-side surface of the second lens 820 may be convex in a paraxial region, and an image-side surface of the second lens 820 may be concave in a paraxial region. The second lens 820 may be a high-index lens having a refractive index of 1.6 or more.

The third lens 830 may have positive refractive power. An object-side surface of the third lens 830 may be convex in a paraxial region, and an image-side surface of the third lens 830 may be concave in a paraxial region.

The fourth lens 840 may have positive refractive power. An object-side surface of the fourth lens 840 may be concave in a paraxial region, and an image-side surface of the fourth lens 840 may be convex in a paraxial region.

The fifth lens 850 may have negative refractive power. An object-side surface of the fifth lens 850 may be convex in a paraxial region, and an image-side surface of the fifth lens 850 may be concave in a paraxial region. The fifth lens 850 may be a high-index lens having a refractive index of 1.6 or more.

The sixth lens 860 may have negative refractive power. An object-side surface of the sixth lens 860 may be convex in a paraxial region, and an image-side surface of the sixth lens 860 may be concave in a paraxial region.

The seventh lens 870 may have positive refractive power. An object-side surface and an image-side surface of the seventh lens 870 may be convex in a paraxial region. The seventh lens 870 may be provided as a D-cut lens.

The eighth lens 880 may have negative refractive power. An object-side surface and an image-side surface of the eighth lens 880 may be concave in a paraxial region. The eighth lens 880 may be provided as a D-cut lens.

According to the eighth embodiment, the prism P may be formed of a glass material, and the first lens 810 to the eighth lens 880 may be formed of a plastic material. Further, object-side surfaces and image-side surfaces of the first lens 810 to the eighth lens 880 may be aspherical.

Table 15 lists characteristics of individual lenses included in the optical imaging system 800 according to the eighth embodiment, and Table 16 lists aspheric coefficients of individual lenses included in the optical imaging system 800 according to the eighth embodiment.

TABLE 15

| | | | Thick- | | | |
|---|---|---|---|---|---|---|
| Sur- | | | ness/ | Refrac- | Abbe | |
| face | | Radius of | dis- | tive | num- | Focal |
| No. | Note | curvature | tance | index | ber | length |
| Object | | Infinity | Infinity | | | |
| 1 | Prism | Infinity | 4.200 | 2.116 | 17.02 | |
| 2 | | Infinity | 4.200 | 2.116 | 17.02 | |
| 3 | | Infinity | 2.000 | | | |
| 4 | Stop | Infinity | 1.795 | | | |
| 5 | First lens | 4.612 | 1.975 | 1.544 | 55.99 | 9.831 |
| 6 | | 27.892 | 0.117 | | | |
| 7 | Second lens | 22.204 | 0.390 | 1.693 | 18.41 | −22.747 |
| 8 | | 9.155 | 0.968 | | | |
| 9 | Third lens | 16.009 | 0.594 | 1.544 | 55.99 | 258.272 |
| 10 | | 17.824 | 0.319 | | | |
| 11 | Fourth lens | −29.662 | 0.866 | 1.544 | 55.99 | 33.048 |
| 12 | | −11.332 | 0.050 | | | |
| 13 | Fifth lens | 33.166 | 0.492 | 1.693 | 18.41 | −47.595 |
| 14 | | 16.440 | 0.781 | | | |
| 15 | Sixth lens | 18.099 | 0.962 | 1.567 | 37.40 | −500.227 |
| 16 | | 16.690 | 0.641 | | | |
| 17 | Seventh lens | 7.760 | 0.987 | 1.565 | 41.52 | 12.453 |
| 18 | | −75.027 | 1.545 | | | |
| 19 | Eighth lens | −12.998 | 0.882 | 1.534 | 55.90 | −7.398 |
| 20 | | 5.850 | 0.800 | | | |
| 21 | Filter | Infinity | 0.210 | 1.517 | 64.20 | |
| 22 | | Infinity | 0.716 | | | |
| Image | | Infinity | | | | |

TABLE 16

| Note | 5 | 6 | 7 | 8 | 9 | 10 | 11 | 12 |
|---|---|---|---|---|---|---|---|---|
| Conic | −0.528 | −30.361 | −0.076 | 3.715 | −86.126 | −48.377 | 70.010 | 0.000 |
| constant | | | | | | | | |
| (K) | | | | | | | | |
| 4th order | −2.107E−01 | −4.648E−02 | −2.565E−01 | −1.735E−01 | 2.625E−01 | 3.428E−01 | 1.195E−01 | 2.294E−01 |
| coefficient | | | | | | | | |
| (A) | | | | | | | | |
| 6th order | 1.525E−02 | 2.843E−02 | −6.650E−02 | −8.351E−02 | −3.484E−02 | −4.465E−02 | −1.725E−03 | 5.522E−02 |
| coefficient | | | | | | | | |
| (B) | | | | | | | | |
| 8th order | 1.903E−02 | 8.479E−03 | −5.841E−03 | −1.667E−02 | −1.352E−02 | −2.948E−02 | −2.408E−02 | −5.705E−03 |
| coefficient | | | | | | | | |
| (C) | | | | | | | | |
| 10th order | 9.513E−03 | 3.265E−03 | 1.258E−04 | −3.723E−03 | 2.468E−03 | −1.368E−03 | −3.824E−03 | −1.420E−03 |
| coefficient | | | | | | | | |
| (D) | | | | | | | | |
| 12th order | 2.931E−03 | 9.084E−04 | 8.039E−04 | 4.115E−04 | 1.298E−03 | −9.872E−04 | −1.398E−03 | −1.507E−03 |
| coefficient | | | | | | | | |
| (E) | | | | | | | | |
| 14th order | 1.042E−03 | 1.736E−04 | 3.507E−04 | 9.532E−04 | 1.286E−03 | 3.574E−04 | −2.592E−04 | 2.077E−03 |
| coefficient | | | | | | | | |
| (F) | | | | | | | | |
| 16th order | 1.915E−04 | 1.879E−04 | 1.774E−04 | 7.950E−04 | 5.547E−04 | 3.399E−04 | 2.405E−04 | −1.659E−03 |
| coefficient | | | | | | | | |
| (G) | | | | | | | | |
| 18th order | 1.716E−04 | −1.885E−04 | −2.489E−04 | 2.917E−04 | 3.117E−04 | 4.519E−04 | 1.877E−04 | 3.403E−04 |
| coefficient | | | | | | | | |
| (H) | | | | | | | | |
| 20th order | 8.676E−06 | 1.219E−04 | 8.866E−06 | 1.248E−04 | 4.242E−05 | 9.467E−05 | 1.093E−04 | −4.134E−04 |
| coefficient | | | | | | | | |
| (J) | | | | | | | | |
| 22nd order | 5.825E−05 | −7.757E−05 | −1.037E−04 | −3.145E−05 | 1.907E−05 | 6.074E−05 | −2.806E−05 | 1.424E−04 |
| coefficient | | | | | | | | |
| (L) | | | | | | | | |
| 24th order | −7.962E−06 | 5.202E−05 | 1.221E−05 | −3.155E−05 | −2.837E−05 | −2.243E−05 | 2.418E−05 | −1.119E−04 |
| coefficient | | | | | | | | |
| (M) | | | | | | | | |
| 26th order | 1.896E−05 | −2.097E−05 | −2.305E−05 | −4.520E−05 | −1.458E−05 | 3.353E−06 | −2.047E−05 | 3.505E−05 |
| coefficient | | | | | | | | |
| (N) | | | | | | | | |
| 28th order | −1.822E−05 | 1.629E−05 | 1.856E−05 | −7.951E−06 | −1.935E−05 | −1.937E−05 | 2.604E−05 | −4.359E−05 |
| coefficient | | | | | | | | |
| (O) | | | | | | | | |
| 30th order | −2.140E−06 | −1.917E−05 | 1.785E−06 | 7.843E−06 | 7.179E−06 | 1.915E−06 | −5.644E−06 | 2.042E−05 |
| coefficient | | | | | | | | |
| (P) | | | | | | | | |
| Note | 13 | 14 | 15 | 16 | 17 | 18 | 19 | 20 |
| Conic | −19.114 | −58.990 | 13.632 | −9.954 | −8.793 | 95.003 | 0.000 | −18.886 |
| constant | | | | | | | | |
| (K) | | | | | | | | |
| 4th order | 7.860E−01 | 8.685E−01 | 1.040E+00 | 1.563E+00 | 2.365E+00 | 1.027E+00 | 1.994E+00 | 3.180E+00 |
| coefficient | | | | | | | | |
| (A) | | | | | | | | |
| 6th order | 3.306E−02 | 2.429E−02 | 9.518E−02 | −1.907E−01 | −4.617E−02 | 4.940E−02 | −1.070E+00 | −5.517E−01 |
| coefficient | | | | | | | | |
| (B) | | | | | | | | |
| 8th order | 4.789E−03 | 2.086E−03 | 2.888E−02 | −7.005E−03 | −1.425E−01 | −7.251E−02 | 3.056E−01 | 1.340E−01 |
| coefficient | | | | | | | | |
| (C) | | | | | | | | |
| 10th order | −7.553E−04 | −1.532E−03 | 2.784E−03 | −1.476E−02 | −3.349E−02 | 2.692E−02 | −5.210E−02 | −7.986E−02 |
| coefficient | | | | | | | | |
| (D) | | | | | | | | |
| 12th order | −9.155E−04 | −1.841E−03 | 2.697E−03 | 4.041E−03 | 5.997E−03 | −8.452E−03 | −7.697E−03 | 1.832E−02 |
| coefficient | | | | | | | | |
| (E) | | | | | | | | |
| 14th order | 5.549E−04 | −2.783E−03 | −5.121E−03 | −4.552E−03 | 1.230E−03 | 2.912E−04 | −1.382E−03 | −1.281E−02 |
| coefficient | | | | | | | | |
| (F) | | | | | | | | |
| 16th order | −3.118E−03 | −2.919E−03 | −4.532E−03 | −1.894E−03 | −3.452E−03 | 5.076E−03 | 1.776E−02 | 5.928E−03 |
| coefficient | | | | | | | | |
| (G) | | | | | | | | |
| 18th order | −6.290E−04 | −8.366E−04 | −1.979E−03 | 1.428E−03 | −2.597E−03 | 4.454E−04 | −5.305E−03 | −1.082E−03 |
| coefficient | | | | | | | | |
| (H) | | | | | | | | |
| 20th order | −5.825E−04 | −2.873E−04 | 2.291E−04 | 1.667E−03 | 1.064E−03 | −9.428E−04 | −3.876E−03 | 1.880E−03 |
| coefficient | | | | | | | | |
| (J) | | | | | | | | |
| 22nd order | 8.686E−05 | −4.661E−05 | 5.529E−04 | 3.216E−04 | 1.942E−03 | −6.294E−04 | 9.581E−04 | 3.533E−04 |
| coefficient | | | | | | | | |
| (L) | | | | | | | | |
| 24th order | −3.267E−05 | −1.881E−05 | 4.661E−04 | −4.338E−04 | 1.330E−03 | 7.457E−05 | 1.340E−03 | 4.238E−04 |
| coefficient | | | | | | | | |
| (M) | | | | | | | | |
| 26th order | 6.737E−05 | 2.586E−05 | 1.452E−04 | −2.612E−04 | 4.978E−04 | 1.152E−04 | −2.915E−04 | −7.270E−05 |
| coefficient | | | | | | | | |
| (N) | | | | | | | | |
| 28th order | 4.915E−06 | 1.937E−05 | 4.313E−05 | −4.912E−05 | 2.731E−05 | −6.790E−05 | −3.105E−04 | −1.048E−04 |
| coefficient | | | | | | | | |
| (O) | | | | | | | | |
| 30th order | 1.997E−05 | 2.101E−05 | −8.458E−05 | 8.072E−05 | −7.048E−05 | −1.004E−04 | 6.112E−05 | −1.657E−05 |
| coefficient | | | | | | | | |
| (P) | | | | | | | | |

### Ninth Embodiment

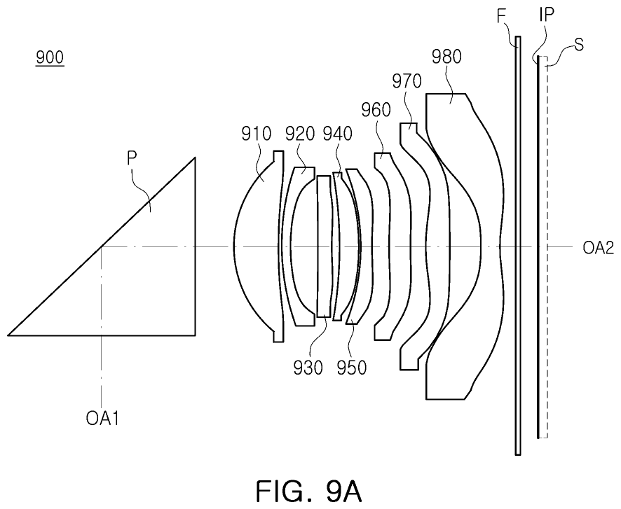

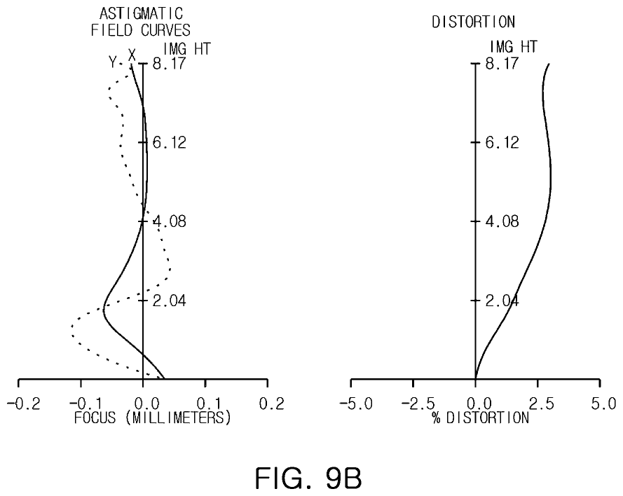

FIG. 9A is a configuration diagram illustrating an optical imaging system according to a ninth embodiment. FIG. 9B is a graph indicating aberration properties of an optical imaging system according to a ninth embodiment.

An optical imaging system 900 according to the ninth embodiment may include a first lens 910, a second lens 920, a third lens 930, a fourth lens 940, a fifth lens 950, a sixth lens 960, a seventh lens 970, and an eighth lens 980.

A prism P may be disposed on an object side of the first lens 910 as an optical path (OA1) direction to a second optical axis (OA2) direction. The first lens 910 to the eighth lens 980 may be disposed in order in the second optical axis (OA2) direction.

A filter F and an image sensor S may be disposed on an image side of the eight lens 980. Incident light may pass through the first lens 910 to the eighth lens 980 and the filter F in order, and may be received at an imaging plane IP of the image sensor S.

Also, a stop may be disposed between the prism P and the first lens 910. Specifically, the stop may be disposed between an exit surface of the prism P and the first lens 910.

The first lens 910 may have positive refractive power. An object-side surface of the first lens 910 may be convex in a paraxial region, and an image-side surface of the first lens 910 may be concave in a paraxial region.

The second lens 920 may have negative refractive power. An object-side surface of the second lens 920 may be convex in a paraxial region, and an image-side surface of the second lens 920 may be concave in a paraxial region. The second lens 920 may be a high-index lens having a refractive index of 1.6 or more.

The third lens 930 may have positive refractive power. An object-side surface of the third lens 930 may be convex in a paraxial region, and an image-side surface of the third lens 930 may be concave in a paraxial region.

The fourth lens 940 may have positive refractive power. An object-side surface of the fourth lens 940 may be concave in a paraxial region, and an image-side surface of the fourth lens 940 may be convex in a paraxial region.

The fifth lens 950 may have negative refractive power. An object-side surface of the fifth lens 950 may be convex in a paraxial region, and an image-side surface of the fifth lens 950 may be concave in a paraxial region. The fifth lens 950 may be a high-index lens having a refractive index of 1.6 or more.

The sixth lens 960 may have negative refractive power. An object-side surface of the sixth lens 960 may be convex in a paraxial region, and an image-side surface of the sixth lens 960 may be concave in a paraxial region.

The seventh lens 970 may have positive refractive power. An object-side surface and an image-side surface of the seventh lens 970 may be convex in a paraxial region. The seventh lens 970 may be provided as a D-cut lens.

The eighth lens 980 may have negative refractive power. An object-side surface and an image-side surface of the eighth lens 980 may be concave in a paraxial region. The eighth lens 980 may be provided as a D-cut lens.

According to the ninth embodiment, the prism P may be formed of a glass material, and the first lens 910 to the eighth lens 980 may be formed of a plastic material. Further, object-side surfaces and image-side surfaces of the first lens 910 to the eighth lens 980 may be aspherical.

Table 17 lists characteristics of individual lenses included in the optical imaging system 900 according to the ninth embodiment, and Table 18 lists aspheric coefficients of individual lenses included in the optical imaging system 900 according to the ninth embodiment.

TABLE 17

| | | | Thick- | | | |
|---|---|---|---|---|---|---|
| Sur- | | | ness/ | Refrac- | Abbe | |
| face | | Radius of | dis- | tive | num- | Focal |
| No. | Note | curvature | tance | index | ber | length |
| Object | | Infinity | Infinity | | | |
| 1 | Prism | Infinity | 4.200 | 2.116 | 17.02 | |
| 2 | | Infinity | 4.200 | 2.116 | 17.02 | |
| 3 | | Infinity | 2.000 | | | |
| 4 | Stop | Infinity | 1.790 | | | |
| 5 | First lens | 4.615 | 1.998 | 1.544 | 55.99 | 9.839 |
| 6 | | 27.824 | 0.154 | | | |
| 7 | Second lens | 21.916 | 0.390 | 1.693 | 18.41 | −22.805 |
| 8 | | 9.118 | 0.961 | | | |
| 9 | Third lens | 16.143 | 0.624 | 1.551 | 49.63 | 257.219 |
| 10 | | 17.957 | 0.339 | | | |
| 11 | Fourth lens | −29.574 | 0.870 | 1.544 | 55.99 | 30.509 |
| 12 | | −10.764 | 0.050 | | | |
| 13 | Fifth lens | 35.866 | 0.515 | 1.693 | 18.41 | −45.213 |
| 14 | | 16.629 | 0.798 | | | |
| 15 | Sixth lens | 18.932 | 0.958 | 1.581 | 34.85 | −870.963 |
| 16 | | 17.913 | 0.686 | | | |
| 17 | Seventh lens | 8.095 | 1.075 | 1.565 | 41.52 | 12.588 |
| 18 | | −58.095 | 1.399 | | | |
| 19 | Eighth lens | −11.031 | 0.850 | 1.534 | 55.90 | −7.287 |
| 20 | | 6.219 | 0.800 | | | |
| 21 | Filter | Infinity | 0.210 | 1.517 | 64.20 | |
| 22 | | Infinity | 0.702 | | | |
| Image | | Infinity | | | | |

TABLE 18

| Note | 5 | 6 | 7 | 8 | 9 | 10 | 11 | 12 |
|---|---|---|---|---|---|---|---|---|
| Conic | −0.518 | −30.387 | 37.629 | 3.645 | −86.697 | −46.335 | 69.056 | 0.000 |
| constant | | | | | | | | |
| (K) | | | | | | | | |
| 4th order | 2.140E−01 | 4.543E−02 | 1.329E−01 | 1.692E−01 | −2.614E−01 | −3.408E−01 | −1.166E−01 | −2.165E−01 |
| coefficient | | | | | | | | |
| (A) | | | | | | | | |
| 6th order | −1.680E−02 | −2.949E−02 | 4.186E−02 | 8.053E−02 | 3.299E−02 | 4.401E−02 | 1.539E−03 | −5.677E−02 |
| coefficient | | | | | | | | |
| (B) | | | | | | | | |
| 8th order | −1.859E−02 | −8.160E−03 | −8.744E−04 | 1.572E−02 | 1.135E−02 | 2.803E−02 | 2.422E−02 | 6.098E−03 |
| coefficient | | | | | | | | |
| (C) | | | | | | | | |
| 10th order | −9.730E−03 | −1.854E−03 | −1.595E−03 | 3.030E−03 | −2.619E−03 | 1.594E−03 | 3.932E−03 | 1.022E−03 |
| coefficient | | | | | | | | |
| (D) | | | | | | | | |
| 12th order | −2.574E−03 | −8.070E−04 | −1.327E−03 | −2.085E−04 | −1.320E−03 | −9.054E−04 | 1.197E−03 | 1.747E−03 |
| coefficient | | | | | | | | |
| (E) | | | | | | | | |
| 14th order | −9.929E−04 | −1.718E−04 | −7.964E−04 | −8.736E−04 | −9.893E−04 | −4.220E−04 | −1.142E−04 | −2.295E−03 |
| coefficient | | | | | | | | |
| (F) | | | | | | | | |
| 16th order | −5.589E−06 | −5.391E−05 | −1.863E−04 | −4.828E−04 | −4.207E−04 | −3.007E−04 | −2.105E−04 | 1.754E−03 |
| coefficient | | | | | | | | |
| (G) | | | | | | | | |
| 18th order | −1.502E−04 | 5.378E−05 | −6.724E−05 | −2.464E−04 | −1.388E−04 | −3.263E−04 | −1.418E−04 | −4.735E−04 |
| coefficient | | | | | | | | |
| (H) | | | | | | | | |
| 20th order | 4.968E−05 | −3.549E−05 | −9.843E−06 | −3.561E−05 | −2.376E−06 | −5.420E−05 | −5.559E−05 | 4.811E−04 |
| coefficient | | | | | | | | |
| (J) | | | | | | | | |
| 22nd order | −6.605E−05 | 3.420E−05 | −2.098E−06 | 1.194E−05 | 3.261E−05 | −3.616E−05 | 2.812E−05 | −1.877E−04 |
| coefficient | | | | | | | | |
| (L) | | | | | | | | |
| 24th order | 2.603E−05 | −2.510E−05 | −8.419E−06 | 3.573E−05 | 2.287E−05 | 1.284E−05 | −1.604E−05 | 1.403E−04 |
| coefficient | | | | | | | | |
| (M) | | | | | | | | |
| 26th order | −3.133E−05 | 1.959E−05 | 2.214E−06 | 2.220E−05 | 2.043E−05 | −1.130E−05 | 3.026E−06 | −5.753E−05 |
| coefficient | | | | | | | | |
| (N) | | | | | | | | |
| 28th order | 2.206E−05 | −8.787E−06 | −4.087E−06 | 9.809E−06 | 5.179E−06 | 1.098E−05 | −2.063E−05 | 5.667E−05 |
| coefficient | | | | | | | | |
| (O) | | | | | | | | |
| 30th order | −2.011E−06 | 1.666E−05 | 5.523E−07 | −6.695E−06 | −7.068E−06 | −5.132E−07 | 4.684E−06 | −2.195E−05 |
| coefficient | | | | | | | | |
| (P) | | | | | | | | |
| Note | 13 | 14 | 15 | 16 | 17 | 18 | 19 | 20 |
| Conic | −24.532 | −53.569 | 11.087 | −9.941 | −9.372 | 99.000 | 0.000 | −19.030 |
| constant | | | | | | | | |
| (K) | | | | | | | | |
| 4th order | −7.797E−01 | −8.732E−01 | −1.020E+00 | −1.579E+00 | −2.318E+00 | −1.120E+00 | −1.684E+00 | −3.074E+00 |
| coefficient | | | | | | | | |
| (A) | | | | | | | | |
| 6th order | −3.563E−02 | −2.388E−02 | −9.258E−02 | 1.973E−01 | 5.232E−02 | −8.143E−02 | 1.049E+00 | 5.975E−01 |
| coefficient | | | | | | | | |
| (B) | | | | | | | | |
| 8th order | −5.181E−03 | −2.502E−03 | −3.216E−02 | 1.073E−02 | 1.276E−01 | 6.369E−02 | −3.036E−01 | −1.273E−01 |
| coefficient | | | | | | | | |
| (C) | | | | | | | | |
| 10th order | 4.868E−04 | 1.826E−03 | −5.171E−03 | 1.686E−02 | 3.055E−02 | −3.187E−02 | 5.501E−02 | 8.499E−02 |
| coefficient | | | | | | | | |
| (D) | | | | | | | | |
| 12th order | 1.758E−03 | 2.822E−03 | −5.040E−03 | −4.675E−03 | −6.706E−03 | 6.791E−03 | 4.713E−03 | −1.873E−02 |
| coefficient | | | | | | | | |
| (E) | | | | | | | | |
| 14th order | −4.127E−04 | 2.748E−03 | 2.632E−03 | 4.184E−03 | 1.969E−05 | −2.153E−03 | −3.975E−03 | 1.344E−02 |
| coefficient | | | | | | | | |
| (F) | | | | | | | | |
| 16th order | 2.903E−03 | 2.510E−03 | 2.812E−03 | 1.958E−03 | 5.095E−03 | −4.399E−03 | −1.673E−02 | −6.753E−03 |
| coefficient | | | | | | | | |
| (G) | | | | | | | | |
| 18th order | 3.239E−04 | 5.606E−04 | 1.618E−03 | −2.267E−04 | 3.272E−03 | 9.599E−04 | 9.151E−03 | 1.825E−03 |
| coefficient | | | | | | | | |
| (H) | | | | | | | | |
| 20th order | 5.319E−04 | 2.592E−04 | 2.317E−04 | −8.574E−04 | −1.290E−03 | 3.131E−03 | 3.996E−03 | −2.218E−03 |
| coefficient | | | | | | | | |
| (J) | | | | | | | | |
| 22nd order | −1.389E−04 | 8.552E−06 | −2.885E−05 | −2.244E−04 | −2.157E−03 | 2.540E−03 | −1.987E−03 | −1.065E−04 |
| coefficient | | | | | | | | |
| (L) | | | | | | | | |
| 24th order | 4.842E−05 | 3.426E−05 | −1.185E−04 | 1.094E−04 | −1.021E−03 | 1.167E−03 | −2.008E−03 | −5.071E−04 |
| coefficient | | | | | | | | |
| (M) | | | | | | | | |
| 26th order | −6.804E−05 | −2.694E−05 | −2.022E−05 | 6.241E−05 | 4.795E−06 | 1.274E−04 | 1.842E−04 | 1.082E−04 |
| coefficient | | | | | | | | |
| (N) | | | | | | | | |
| 28th order | 1.145E−05 | −4.417E−06 | −2.944E−05 | −5.709E−07 | 2.191E−04 | −1.193E−04 | 3.337E−04 | −1.3798E−05 |
| coefficient | | | | | | | | |
| (O) | | | | | | | | |
| 30th order | −9.310E−06 | −2.454E−05 | 2.164E−05 | −3.212E−05 | 1.180E−04 | −8.425E−05 | 4.646E−05 | 3.719E−05 |
| coefficient | | | | | | | | |
| (P) | | | | | | | | |

### 10th Embodiment

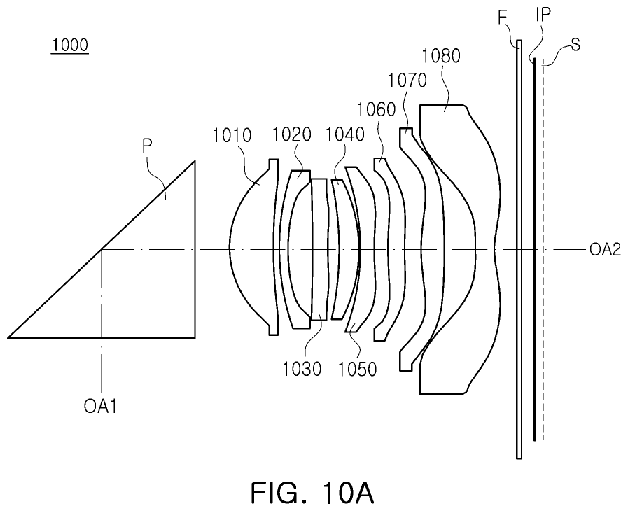

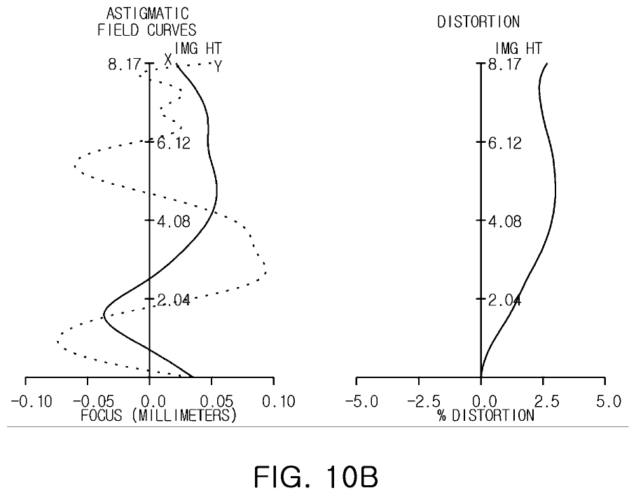

FIG. 10A is a configuration diagram illustrating an optical imaging system according to a 10th embodiment. FIG. 10B is a graph indicating aberration properties of an optical imaging system according to a 10th embodiment.

The optical imaging system 1000 according to the 10th embodiment may include a first lens 1010, a second lens 1020, a third lens 1030, a fourth lens 1040, a fifth lens 1050, a sixth lens 1060, a seventh lens 1070, and an eighth lens 1080.

A prism P may be disposed on an object side of the first lens 1010 as an optical path (OA1) direction to a second optical axis (OA2) direction. The first lens 1010 to the eighth lens 1080 may be disposed in order in the second optical axis (OA2) direction.

A filter F and an image sensor S may be disposed on an image side of the eight lens 1080. Incident light may pass through the first lens 1010 to the eighth lens 1080 and the filter F in order and may be received at an imaging plane IP of the image sensor S.

Also, a stop may be disposed between the prism P and the first lens 1010. Specifically, the stop may be disposed between an exit surface of the prism P and the first lens 1010.

The first lens 1010 may have positive refractive power. An object-side surface of the first lens 1010 may be convex in a paraxial region, and an image-side surface of the first lens 1010 may be concave in a paraxial region.

The second lens 1020 may have negative refractive power. An object-side surface of the second lens 1020 may be convex in a paraxial region, and an image-side surface of the second lens 1020 may be concave in a paraxial region. The second lens 1020 may be a high-index lens having a refractive index of 1.6 or more.

The third lens 1030 may have positive refractive power. An object-side surface of the third lens 1030 may be convex in a paraxial region, and an image-side surface of the third lens 1030 may be concave in a paraxial region.

The fourth lens 1040 may have positive refractive power. An object-side surface of the fourth lens 1040 may be concave in a paraxial region, and an image-side surface of the fourth lens 1040 may be convex in a paraxial region.

The fifth lens 1050 may have negative refractive power. An object-side surface of the fifth lens 1050 may be convex in a paraxial region, and an image-side surface of the fifth lens 1050 may be concave in a paraxial region. The fifth lens 1050 may be a high-index lens having a refractive index of 1.6 or more.

The sixth lens 1060 may have positive refractive power. An object-side surface of the sixth lens 1060 may be convex in a paraxial region, and an image-side surface of the sixth lens 1060 may be concave in a paraxial region.

The seventh lens 1070 may have positive refractive power. An object-side surface and an image-side surface of the seventh lens 1070 may be convex in a paraxial region. The seventh lens 1070 may be provided as a D-cut lens.

The eighth lens 1080 may have negative refractive power. An object-side surface of the eighth lens 1080 may be convex in a paraxial region, and an image-side surface of the eighth lens 1080 may be concave in a paraxial region. The eighth lens 1080 may be provided as a D-cut lens.

According to the 10th embodiment, the prism P may be formed of a glass material, and the first lens 1010 to the eighth lens 1080 may be formed of a plastic material. Further, object-side surfaces and image-side surfaces of the first lens 1010 to the eighth lens 1080 may be aspherical.

Table 19 lists the characteristics of individual lenses included in the optical imaging system 1000 according to the 10th embodiment, and Table 20 lists the aspheric coefficients of individual lenses included in the optical imaging system 1000 according to the 10th embodiment.

TABLE 19

| Sur- | | | Thick- | Refrac- | Abbe | |
|---|---|---|---|---|---|---|
| face | | Radius of | ness/dis- | tive | num- | Focal |
| No. | Note | curvature | tance | index | ber | length |
| Object | | Infinity | Infinity | | | |
| 1 | Prism | Infinity | 4.200 | 2.116 | 17.02 | |
| 2 | | Infinity | 4.200 | 2.116 | 17.02 | |
| 3 | | Infinity | 2.000 | | | |
| 4 | Stop | Infinity | 1.772 | | | |
| 5 | First lens | 4.623 | 1.884 | 1.544 | 55.99 | 9.876 |
| 6 | | 27.820 | 0.207 | | | |
| 7 | Second lens | 21.974 | 0.391 | 1.693 | 18.41 | −23.963 |
| 8 | | 9.392 | 0.954 | | | |
| 9 | Third lens | 17.592 | 0.690 | 1.553 | 48.70 | 463.712 |
| 10 | | 18.619 | 0.353 | | | |
| 11 | Fourth lens | −29.317 | 0.885 | 1.544 | 55.99 | 33.671 |
| 12 | | −11.416 | 0.050 | | | |
| 13 | Fifth lens | 32.137 | 0.640 | 1.693 | 18.41 | −39.961 |
| 14 | | 14.757 | 0.621 | | | |
| 15 | Sixth lens | 15.884 | 0.744 | 1.587 | 33.14 | 228.355 |
| 16 | | 17.695 | 0.743 | | | |
| 17 | Seventh lens | 8.386 | 1.040 | 1.562 | 40.65 | 12.611 |
| 18 | | −44.780 | 1.393 | | | |
| 19 | Eighth lens | 57.270 | 0.850 | 1.534 | 55.90 | −7.396 |
| 20 | | 3.692 | 0.800 | | | |
| 21 | Filter | Infinity | 0.210 | 1.517 | 64.20 | |
| 22 | | Infinity | 0.800 | | | |
| Image | | Infinity | | | | |

TABLE 20

| Note | 5 | 6 | 7 | 8 | 9 | 10 | 11 | 12 |
|---|---|---|---|---|---|---|---|---|
| Conic | −0.473 | −21.017 | 36.708 | 2.741 | −86.078 | −28.571 | 53.215 | 0.000 |
| constant | | | | | | | | |
| (K) | | | | | | | | |
| 4th order | 2.165E−01 | 5.284E−02 | 1.286E−01 | 1.789E−01 | −2.642E−01 | −3.307E−01 | −1.068E−01 | −2.380E−01 |
| coefficient | | | | | | | | |
| (A) | | | | | | | | |
| 6th order | −1.031E−02 | −2.938E−02 | 4.656E−02 | 8.174E−02 | 3.032E−02 | 4.027E−02 | 7.618E−04 | −5.000E−02 |
| coefficient | | | | | | | | |
| (B) | | | | | | | | |
| 8th order | −1.542E−02 | −8.041E−03 | 6.780E−03 | 2.263E−02 | 1.400E−02 | 3.131E−02 | 2.647E−02 | 3.331E−03 |
| coefficient | | | | | | | | |
| (C) | | | | | | | | |
| 10th order | −1.017E−02 | −4.394E−03 | −2.182E−03 | 4.144E−03 | −1.089E−03 | 1.559E−03 | 2.730E−03 | 1.622E−03 |
| coefficient | | | | | | | | |
| (D) | | | | | | | | |
| 12th order | −3.173E−03 | −1.284E−03 | −6.886E−04 | 8.479E−04 | −1.073E−03 | 4.982E−04 | 4.565E−04 | 1.792E−03 |
| coefficient | | | | | | | | |
| (E) | | | | | | | | |
| 14th order | −1.701E−03 | −5.262E−04 | −9.363E−04 | −1.046E−03 | −1.058E−03 | −9.651E−04 | −4.755E−04 | −2.517E−03 |
| coefficient | | | | | | | | |
| (F) | | | | | | | | |
| 16th order | −2.582E−04 | −1.671E−04 | −1.448E−04 | −6.575E−04 | −5.591E−04 | −5.463E−04 | −3.689E−04 | 1.867E−03 |
| coefficient | | | | | | | | |
| (G) | | | | | | | | |
| 18th order | −3.533E−04 | 3.171E−05 | −1.248E−05 | −5.034E−04 | −1.531E−04 | −4.478E−04 | −2.611E−04 | −8.009E−04 |
| coefficient | | | | | | | | |
| (H) | | | | | | | | |
| 20th order | 2.960E−05 | −2.737E−05 | 6.408E−05 | −1.215E−04 | 7.083E−07 | 3.423E−05 | 1.078E−05 | 6.328E−04 |
| coefficient | | | | | | | | |
| (J) | | | | | | | | |
| 22nd order | −1.057E−04 | 1.175E−05 | 1.995E−05 | −7.164E−05 | 2.713E−05 | −2.762E−05 | 1.789E−05 | −2.024E−04 |
| coefficient | | | | | | | | |
| (L) | | | | | | | | |
| 24th order | 4.513E−05 | −4.298E−05 | 5.070E−06 | 2.112E−05 | 1.274E−05 | 6.469E−05 | 7.105E−06 | 1.344E−04 |
| coefficient | | | | | | | | |
| (M) | | | | | | | | |
| 26th order | −4.348E−05 | −2.192E−06 | −6.474E−07 | −1.085E−05 | 8.973E−06 | −8.597E−06 | −1.662E−06 | −5.430E−05 |
| coefficient | | | | | | | | |
| (N) | | | | | | | | |
| 28th order | 2.532E−05 | −1.804E−05 | −5.598E−06 | 3.824E−06 | −8.474E−06 | 3.452E−05 | 3.210E−07 | 4.979E−05 |
| coefficient | | | | | | | | |
| (O) | | | | | | | | |
| 30th order | −3.519E−05 | 9.967E−06 | −1.343E−06 | −2.009E−05 | −7.957E−06 | −2.253E−05 | −8.345E−06 | −2.345E−05 |
| coefficient | | | | | | | | |
| (P) | | | | | | | | |
| Note | 13 | 14 | 15 | 16 | 17 | 18 | 19 | 20 |
| Conic | −70.878 | −28.675 | 6.115 | −6.440 | −10.178 | 50.290 | 96.486 | −12.568 |
| constant | | | | | | | | |
| (K) | | | | | | | | |
| 4th order | −7.703E−01 | −8.679E−01 | −9.899E−01 | −1.469E+00 | −2.000E+00 | −1.024E+00 | −4.090E+00 | −3.520E+00 |
| coefficient | | | | | | | | |
| (A) | | | | | | | | |
| 6th order | −3.839E−02 | −3.099E−02 | −8.738E−02 | 1.671E−01 | 2.026E−02 | −9.009E−02 | 1.510E+00 | 7.049E−01 |
| coefficient | | | | | | | | |
| (B) | | | | | | | | |
| 8th order | −5.118E−03 | −5.558E−04 | −2.975E−02 | 8.985E−03 | 7.559E−02 | 1.687E−02 | −4.254E−01 | −1.599E−01 |
| coefficient | | | | | | | | |
| (C) | | | | | | | | |
| 10th order | 2.692E−03 | 1.307E−03 | −8.850E−03 | 1.201E−02 | 2.141E−02 | −4.675E−03 | 1.152E−01 | 1.240E−01 |
| coefficient | | | | | | | | |
| (D) | | | | | | | | |
| 12th order | 3.304E−03 | 3.588E−03 | −3.644E−03 | −1.522E−03 | −6.941E−03 | −5.648E−04 | −3.669E−02 | −3.232E−02 |
| coefficient | | | | | | | | |
| (E) | | | | | | | | |
| 14th order | −1.064E−03 | 1.253E−03 | 1.854E−03 | 3.423E−03 | 3.332E−03 | 8.482E−03 | 1.943E−02 | 2.126E−02 |
| coefficient | | | | | | | | |
| (F) | | | | | | | | |
| 16th order | 2.904E−03 | 2.253E−03 | 2.063E−03 | 1.888E−04 | 2.662E−03 | −3.275E−03 | −2.422E−02 | −1.138E−02 |
| coefficient | | | | | | | | |
| (G) | | | | | | | | |
| 18th order | −1.372E−04 | 3.691E−05 | 8.365E−04 | −2.940E−04 | 6.488E−03 | 2.031E−03 | 5.833E−03 | 2.915E−03 |
| coefficient | | | | | | | | |
| (H) | | | | | | | | |
| 20th order | 6.391E−04 | 2.169E−04 | −2.875E−04 | −4.627E−04 | 1.887E−03 | 4.978E−04 | 1.947E−03 | −4.137E−03 |
| coefficient | | | | | | | | |
| (J) | | | | | | | | |
| 22nd order | −1.102E−04 | 1.996E−05 | 3.670E−07 | 5.700E−04 | −9.941E−04 | 8.475E−04 | 2.135E−03 | −5.028E−04 |
| coefficient | | | | | | | | |
| (L) | | | | | | | | |
| 24th order | 7.967E−05 | 5.885E−05 | 3.468E−05 | 4.052E−04 | −2.033E−03 | 6.417E−04 | −1.728E−03 | −1.041E−03 |
| coefficient | | | | | | | | |
| (M) | | | | | | | | |
| 26th order | −2.780E−05 | 1.995E−05 | 1.390E−04 | 5.790E−05 | −1.061E−03 | 4.243E−04 | −9.296E−04 | −3.251E−04 |
| coefficient | | | | | | | | |
| (N) | | | | | | | | |
| 28th order | 3.062E−05 | 1.511E−05 | 4.376E−05 | −1.252E−04 | −2.411E−04 | 2.328E−04 | −1.019E−04 | −2.264E−04 |
| coefficient | | | | | | | | |
| (O) | | | | | | | | |
| 30th order | 5.249E−06 | −1.147E−05 | 3.789E−05 | −8.911E−05 | 6.192E−05 | 8.251E−05 | 3.133E−04 | −1.210E−04 |
| coefficient | | | | | | | | |
| (P) | | | | | | | | |

Table 21 lists the optical and physical characteristics of the optical imaging system according to embodiments, and Table 22 lists the values of conditional expressions according to embodiments.

TABLE 21

| | First | Second | Third | Fourth | Fifth |
|---|---|---|---|---|---|
| Note | embodiment | embodiment | embodiment | embodiment | embodiment |
| f | 11.165 | 11.076 | 11.031 | 11.028 | 10.986 |
| IMH | 16.332 | 16.332 | 16.332 | 16.332 | 16.332 |
| FOV | 71.020 | 71.003 | 71.220 | 71.234 | 71.442 |
| FNO | 1.477 | 1.477 | 1.477 | 1.477 | 1.477 |
| OAL | 13.664 | 13.453 | 13.406 | 13.439 | 13.397 |
| BFL | 1.760 | 1.750 | 1.749 | 1.739 | 1.738 |
| | Sixth | Seventh | Eighth | Ninth | 10th |
| Note | embodiment | embodiment | embodiment | embodiment | embodiment |
| f | 10.963 | 11.015 | 10.993 | 11.063 | 10.842 |
| IMH | 16.332 | 16.332 | 16.332 | 16.332 | 16.332 |
| FOV | 71.560 | 71.520 | 71.400 | 7.1062 | 72.317 |
| FNO | 1.477 | 1.477 | 1.472 | 1.472 | 1.472 |
| OAL | 13.298 | 13.314 | 13.296 | 13.379 | 13.256 |
| BFL | 1.725 | 1.717 | 1.726 | 1.712 | 1.810 |

TABLE 22

| Conditional | First | Second | Third | Fourth | Fifth |
|---|---|---|---|---|---|
| expression | embodiment | embodiment | embodiment | embodiment | embodiment |
| FOV × IMH/f | 103.885 | 104.701 | 105.445 | 105.491 | 106.209 |
| OAL/IMH | 0.837 | 0.824 | 0.821 | 0.823 | 0.820 |
| FNO × OAL/IMH | 1.236 | 1.217 | 1.212 | 1.215 | 1.212 |
| V1 − V2 | 37.582 | 37.582 | 37.582 | 37.582 | 37.582 |
| V1 − V4 | 0.000 | 0.000 | 0.000 | 0.000 | 0.000 |
| V1 − (V6 + V7)/2 | 18.590 | 18.590 | 18.590 | 16.600 | 16.164 |
| f1/f | 0.843 | 0.849 | 0.853 | 0.858 | 0.864 |
| f2/f | −1.753 | −1.780 | −1.788 | −1.796 | −1.831 |
| \|f3/f\|/10 | 1.473 | 1.868 | 1.829 | 2.353 | 2.366 |
| \|f4/f\| | 2.587 | 2.755 | 2.741 | 2.734 | 2.635 |
| f5/f | −3.448 | −3.551 | −3.555 | −4.010 | −3.992 |
| \|f6/f\|/10 | 1.055 | 1.362 | 1.429 | 1.649 | 1.913 |
| f7/f | 1.162 | 1.135 | 1.139 | 1.147 | 1.137 |
| f8/f | −0.713 | −0.706 | −0.709 | −0.696 | −0.681 |
| f1/f2 | −0.481 | −0.477 | −0.477 | −0.478 | −0.472 |
| f1/f3 | 0.057 | 0.045 | 0.047 | 0.036 | 0.037 |
| OAL/f | 1.224 | 1.215 | 1.215 | 1.219 | 1.219 |
| BFL/f | 0.158 | 0.158 | 0.159 | 0.158 | 0.158 |
| D1/f | 0.015 | 0.015 | 0.014 | 0.015 | 0.017 |
| Conditional | Sixth | Seventh | Eighth | Ninth | 10th |
| expression | embodiment | embodiment | embodiment | embodiment | embodiment |
| FOV × IMH/f | 106.604 | 106.048 | 106.077 | 104.907 | 108.937 |
| OAL/IMH | 0.814 | 0.815 | 0.814 | 0.819 | 0.812 |
| FNO × OAL/IMH | 1.203 | 1.204 | 1.198 | 1.206 | 1.195 |
| V1 − V2 | 37.582 | 37.582 | 37.582 | 37.582 | 37.582 |
| V1 − V4 | 0.000 | 0.000 | 0.000 | 0.000 | 0.000 |
| V1 − (V6 + V7)/2 | 16.918 | 16.319 | 16.532 | 17.948 | 19.099 |
| f1/f | 0.870 | 0.885 | 0.894 | 0.889 | 0.911 |
| f2/f | −1.895 | −2.019 | −2.069 | −2.061 | −2.210 |
| \|f3/f\|/10 | 2.510 | 2.385 | 2.349 | 2.325 | 4.277 |
| \|f4/f\| | 2.383 | 2.819 | 3.006 | 2.758 | 3.106 |
| f5/f | −3.584 | −4.086 | −4.330 | −4.087 | −3.686 |
| \|f6/f\|/10 | 3.306 | 14.940 | 4.550 | 7.873 | 2.106 |
| f7/f | 1.185 | 1.128 | 1.133 | 1.138 | 1.163 |
| f8/f | −0.651 | −0.655 | −0.673 | −0.659 | −0.682 |
| f1/f2 | −0.459 | −0.439 | −0.432 | −0.431 | −0.412 |
| f1/f3 | 0.035 | 0.037 | 0.038 | 0.038 | 0.021 |
| OAL/f | 1.213 | 1.209 | 1.209 | 1.209 | 1.223 |
| BFL/f | 0.157 | 0.156 | 0.157 | 0.155 | 0.167 |
| D1/f | 0.015 | 0.015 | 0.011 | 0.014 | 0.019 |

According to the aforementioned embodiments, the employment into a mobile device having a slim thickness may be available, and high-quality images may be provided.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An optical imaging system, comprising:
a first lens, a second lens, a third lens, a fourth lens, a fifth lens, a sixth lens, a seventh lens, and an eighth lens disposed in order from an object side; and
an optical path conversion member disposed on an object side of the first lens,
wherein a conditional expression 1.3<FNO≤1.5 is satisfied,
where FNO is a value (F-number) representing a brightness of the optical imaging system.

2. The optical imaging system of claim 1, wherein at least one of the seventh lens and the eighth lens is a D-cut lens.

3. The optical imaging system of claim 1, wherein a conditional expression 0.8<OAL/IMH<0.9 is satisfied,
where OAL is a distance on an optical axis from an object-side surface of the first lens to an imaging plane, and IMH is a diagonal length of the imaging plane.

4. The optical imaging system of claim 1, wherein a conditional expression 100°<FOV×IMH/f<120° is satisfied,
where FOV is a field of view of the optical imaging system, IMH is a diagonal length of an imaging plane, and f is a total focal length of the optical imaging system.

5. The optical imaging system of claim 1, wherein a conditional expression 1.1<FNO×(OAL/IMH)≤1.3 is satisfied,
where OAL is a distance on an optical axis from an object-side surface of the first lens to an imaging plane, and IMH is a diagonal length of the imaging plane.

6. The optical imaging system of claim 1, wherein a conditional expression 10<V1−(V6+V7)/2<30 is satisfied,
where V1 is an Abbe number of the first lens, V6 is an Abbe number of the sixth lens, and V7 is an Abbe number of the seventh lens.

7. The optical imaging system of claim 1, wherein a conditional expression 25<V1−V2<45 and 0≤V1−V4<10 is satisfied,
where V1 is an Abbe number of the first lens, V2 is an Abbe number of the second lens, and V4 is an Abbe number of the fourth lens.

8. The optical imaging system of claim 1, wherein a conditional expression 0<f1/f<1 is satisfied,
where f is a total focal length of the optical imaging system, and f1 is a focal length of the first lens.

9. The optical imaging system of claim 1, wherein the first lens, the third lens, and the fourth lens have positive refractive power, and the second lens and the fifth lens have negative refractive power.

10. The optical imaging system of claim 1, wherein the seventh lens has positive refractive power, and an image-side surface of the seventh lens is convex.

11. The optical imaging system of claim 1, wherein the eighth lens has negative refractive power, and an image-side surface of the eighth lens is concave.

12. An optical imaging system, comprising:
an optical path conversion member, a first lens having positive refractive power, a second lens having negative refractive power, a third lens having refractive power, a fourth lens having refractive power, a fifth lens having negative refractive power, a sixth lens having negative refractive power, a seventh lens having refractive power, and an eighth lens having refractive power,
wherein the optical path conversion member changes a traveling path of light incident in a first optical axis direction to a second optical axis direction,
wherein the first to eighth lenses are disposed in the second optical axis direction, and
wherein a conditional expression 1.20<OAL/f<1.35 is satisfied,
where OAL is a distance on a second optical axis from an object-side surface of the first lens to an imaging plane, and f is a total focal length of the optical imaging system.

13. The optical imaging system of claim 12, wherein a conditional expression 2<|f4/f|<4 is satisfied,
where f4 is a focal length of the fourth lens.

14. The optical imaging system of claim 12, wherein the seventh lens has positive refractive power, and a conditional expression 1<f7/f<2 is satisfied,
where f7 is a focal length of the seventh lens.

15. The optical imaging system of claim 12, wherein the eighth lens has negative refractive power, and a conditional expression −1<f8/f<0 is satisfied,
where f8 is a focal length of the eighth lens.

16. The optical imaging system of claim 12, wherein a conditional expression 1<|f3/f|/10<5 is satisfied,
where f3 is a focal length of the third lens.
